(19) United States
(12) Patent Application Publication
(10) Pub. No.: US 2011/0267222 A1
(43) Pub. Date: Nov. 3, 2011

(54) LOCATION DETECTION METHODS AND SYSTEMS

(76) Inventor: Murray Craig, Lakeside, OR (US)

(21) Appl. No.: 13/099,287

(22) Filed: May 2, 2011

Related U.S. Application Data
(60) Provisional application No. 61/330,094, filed on Apr. 30, 2010.

(51) Int. Cl. G01S 13/90; G01S 13/04

(52) U.S. Cl. 342/25 B; 342/28

(57) ABSTRACT

This document discusses, among other things, target, e.g., a vehicle, detection methods and systems that can identify, track, and positionally locate the vehicle using passive sensing of stray signals emitted by a target. The detector can be handheld, in an example, with computing devices, interchangeable antenna units, and a display. The antenna can offer desired gain at specific frequencies of interest. The computing devices can determine the location of the target, e.g., vehicle, aircraft, to within one degree of accuracy. The display can provide this data to a user. In an example, the detector can be a standalone device. In an example, the detector is part of a system that includes a server that can receive data from a plurality of detectors and transmit instructions to the detectors.

### RELATED APPLICATION

The present application claims priority under 35 U.S.C. §119(e) to U.S. Provisional Patent Application No. 61/330,094, filed Apr. 30, 2010, which is hereby incorporated by reference in its entirety for any purpose.

### TECHNICAL FIELD

This document pertains generally to electronic detection methods and systems to determine location of a target, and more particularly, but not by way of limitation, to vehicle detection methods and systems, beacon detection methods and systems, and other target location detection methods and systems.

### BACKGROUND

Location of targets is critical in many environments including security, military, rescue, and protection of vulnerable people. Detecting and tracking vehicles is an important part of a transportation system and border security. It has been recognized that drugs and possibly weapons are smuggled over the U.S. borders. Small vehicles are difficult to remotely sense when they cross or approach the U.S. borders. It is also important and desired to detect improvised explosive devices in military or police settings.

### BRIEF DESCRIPTION OF THE DRAWINGS

FIG. 1A is a diagrammatic view of a detection system according to an embodiment of the present invention.

FIG. 1B is a block diagram showing a detector device processing module according to an embodiment.

FIG. 2 is a diagrammatic view of a detection system according to an embodiment of the present invention.

FIG. 3A is rear perspective view of a handheld detection device according to an embodiment of the present invention.

FIG. 3B is bottom perspective view of a handheld detection device according to an embodiment of the present invention.

FIG. 3C is perspective view of a detection device according to an embodiment of the present invention.

FIG. 3D is diagrammatic view of a detection device in use according to an embodiment of the present invention.

FIG. 4A is diagrammatic view of a detection system according to an embodiment of the present invention.

FIG. 4B is diagrammatic view of a detection system according to an embodiment of the present invention.

FIG. 5 is diagrammatic view of a detection system according to an embodiment of the present invention.

FIG. 6 is diagrammatic view of a detection system according to an embodiment of the present invention.

FIG. 7 is flow chart of a detection method according to an embodiment of the present invention.

FIG. 8A is flow chart of a detection method according to an embodiment of the present invention.

FIG. 8B is flow chart of a detection method according to an embodiment of the present invention.

FIG. 9 is a diagrammatic view of a detection system according to an embodiment of the present invention.

FIG. 10 is a diagrammatic view of an antenna boom assembly according to an embodiment of the present invention.

FIG. 11 is a diagrammatic view of a signal processing assembly according to an embodiment of the present invention.

FIG. 12 is a diagrammatic view of a digital signal processor assembly according to an embodiment of the present invention.

FIG. 13 is a diagrammatic view of an architecture of a detection device according to an embodiment of the present invention.

FIG. 14 is a diagrammatic view of an architecture of a base station according to an embodiment of the present invention.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### OVERVIEW

This overview is intended to provide an overview of subject matter of the present patent application. It is not intended to provide an exclusive or exhaustive explanation of the invention. The detailed description is included to provide further information about the present patent application.

This document also discusses, among other things, location detection methods and systems that can identify, track, and positionally locate targets using either passive sensing of stray signals emitted by a target. The detector according to aspects of the present invention can be handheld, in an example, with computing modules, interchangeable antenna units, and a display. The antenna can offer desired gain at specific frequencies of interest. In an example, the antenna is tuned to a narrow sensing area, e.g., swath of sensing. The computing modules can determine the location of the target to within a certain accuracy (less than five degrees, less than about 2.0 degrees, less than about one degree of accuracy, or about 0.1 degree of accuracy) from the point defined by the device out to a range of a few hundred kilometers. This accuracy is in the elevation and in the range (distance). A display can provide this data to a user. In an example, the detector can be a standalone device. In an example, the detector can be integrated into a further electronic device or a vehicle. In an example, the detector is part of a system that includes a server that can receive data from a plurality of detectors and transmit instructions to the detectors. In a further aspect, a plurality of detectors can communicate directly with other detectors. The detectors and the method of using the detectors described herein can, in various aspects, seek and find any radio frequency source.

This document also discusses, among other things, vehicle detection methods and systems that can identify, track, and positionally locate the vehicle using passive sensing of stray signals emitted by a vehicle. In an example, the vehicles to be detected are aircraft or boats, i.e., vehicles used in illicit border crossings. The detector can be handheld, in an example, with computing devices, interchangeable antenna units, and a display. The antenna can offer desired gain at specific frequencies of interest. In an example, the antenna is tuned to a narrow sensing area, e.g., swath of sensing. The computing devices can determine the location of the vehicle, e.g., aircraft, to within a certain accuracy (less than five degrees, less than about one degree of accuracy, or about 0.1 degree of accuracy). The display can provide this data to a user. In an example, the detector can be a standalone device. In an example, the detector is part of a system that includes a server that can receive data from a plurality of detectors and transmit instructions to the detectors.

While described herein as a vehicle detector, the present devices, systems, and methods can be adapted to track and identify people that are equipped with a transmitter that can be detected as described herein. Such transmitters can be linked to specific people that may be in need of locating. Examples of such people include people afflicted with Alzheimer's or other memory diseases, syndromes and impairments. Such people with the need to be located would need only wear an emitting device that sends a distinctive RF signal that could be detected as described herein. The RF signature would be chosen so as to not interfere with know RF transmissions in the area of where the people are located. The emitters could be integrated into a bracelet or attached to the clothing.

In an example passive aircraft detection system, it includes an antenna to receive stray radio frequency radiation and circuitry coupled to the antenna. The circuitry is to process the received stray radio frequency radiation and to automatically identify a possible aircraft and aircraft position. In an example, the circuitry and antenna do not emit (e.g., free from) an interrogation signal being sent to a target aircraft. In an example, the antenna and the circuitry are configured to sense stray radio frequency emission from an aircraft below 10,000 feet above the ground, or below 1,000 feet from the ground. In an example, the circuitry includes a battery and a solar power recharger to charge the battery. In an example, the circuitry is configured to locate a vehicle with traveling at a speed less than a certain speed, e.g., an aircraft with an airspeed of less than 150 knots. In another example, the circuitry is configured to locate a vehicle traveling at a speed that indicates a motor vehicle, e.g., greater than 10 miles per hour, greater than 20 miles per hour, greater than 30 miles per hour, greater than 40 miles per hour, etc. In an example, the circuitry includes a memory storing radio frequency data representing an aircraft and compares sensed radiation with the stored data to determine if an aircraft is present. In an example, the circuitry is to automatically determine the aircraft type. In an example, the antenna is a phased array antenna tuned to probable frequencies of targets' stray emissions. In an example, a display is provided to display a received signal and directional data. The circuitry can determine and produce signals that cause the display to show three dimensional data within one degree of the target aircraft. In an example, the accuracy is within about 0.1 degree. In an example, the circuitry includes a navigational positioning system. In an example, the circuitry includes topographical data used to determine aircraft position. In an example, the circuitry is to conduct a plurality of reads of received stray radio frequency radiation to identify an aircraft. In an example, the circuitry acts as a software-driven synthetic aperture passive radar device. In an example, a handhold is provided and releasably coupled to the antenna and/or a module containing the circuitry. In an example, the antenna is selected from a group of antennas and is selected to releasably couple to the handhold. Selection and attachment of an antenna can be based on its being tuned to a narrow frequency range and based on the antenna gain for the narrow frequency range. The antenna is tuned to sense in frequency ranges of a 2-3 MHz. In an example, the narrow frequency range is selected from a group consisting of about 120 MHz-123 Mhz, about 145 Mhz-148 Mhz, about 155 Mhz-158 Mhz, about 215 Mhz-218 Mhz, about 242 Mhz-245 Mhz, and 400 Mhz-900 Mhz.

The detector and methods described herein can detect other stray electro-magnetic signals. Examples of such signals can include elements associated with circuitry such as local oscillators, transmission wires, connections in circuitry and the like to name a few. The detector and methods described herein are also used to passively detect radio transmitters. In an aspect, the detector and methods can passively, remotely detect the broadcast of a signal from a radio transmitter, e.g., a handheld transceiver, a walkie-talkie, a two-way radio, an amateur radio transceiver, one-way broadcast radio transmitter, etc., and determine its location.

In an example, a further remote processor, e.g., a computing device or a server, receives data from a mobile detection unit, which can include the detector and circuitry described herein, to further process signals output from the mobile detection unit. In an example, the remote processor or the detector is configured to automatically notify authorities of vehicle detection or aircraft detection. In an example, the remote processor is to notify radar units such that radar unit can focus its radar on likely target area. In an example, the remote processor can further send signals to the mobile detection units to direct the mobile detection unit to focus detection efforts on specific frequencies or for certain vehicle emission patterns

### DETAILED DESCRIPTION

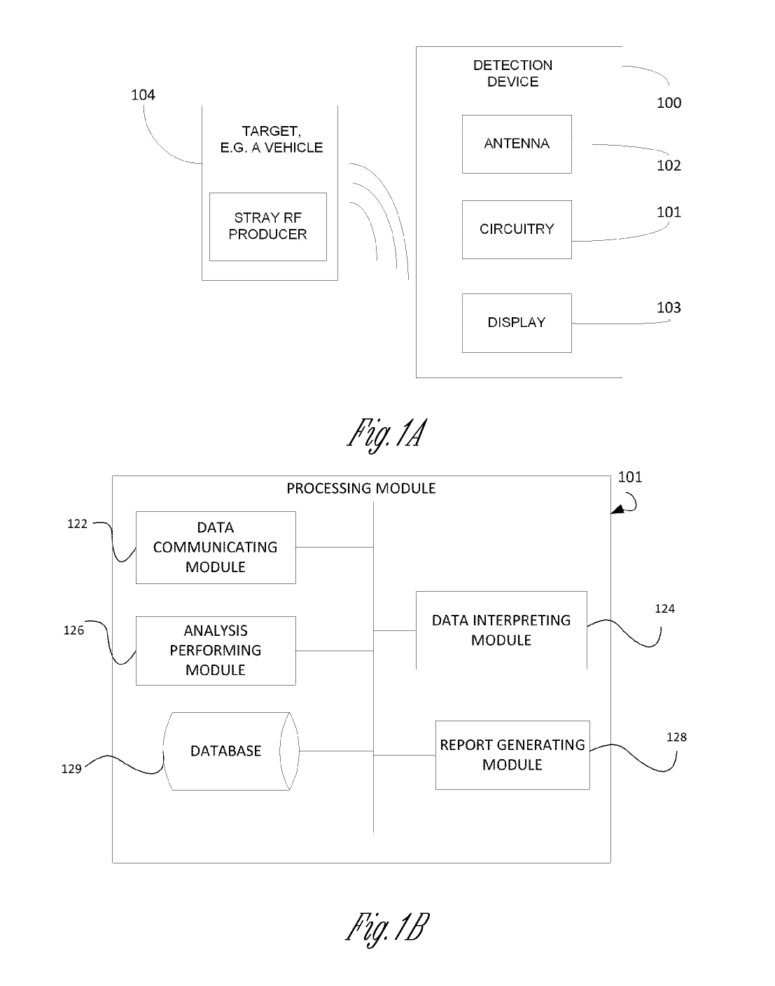

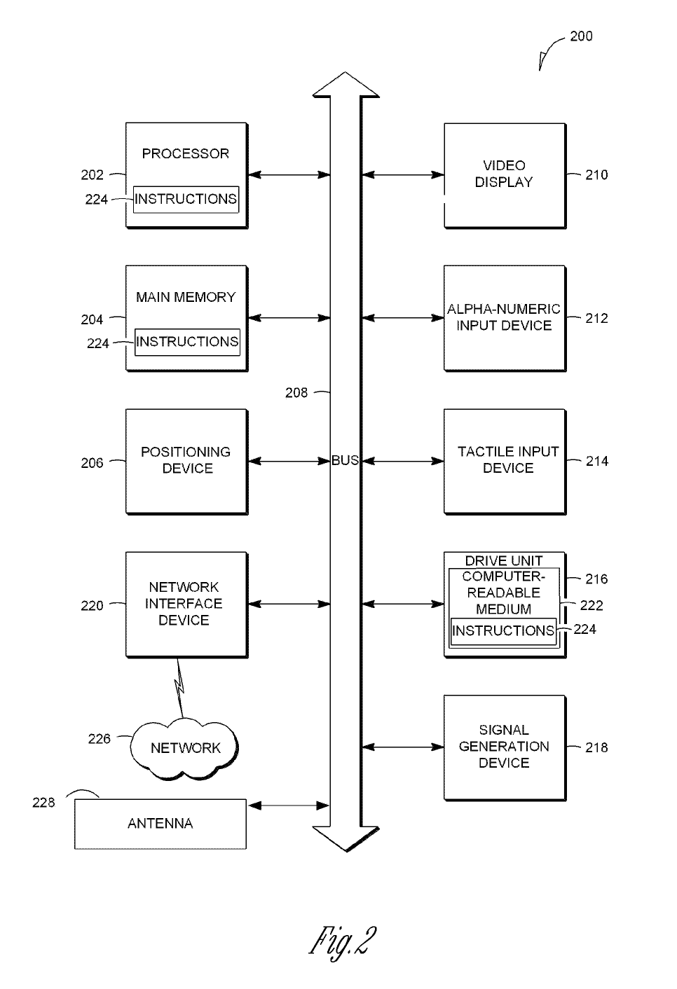

FIG. 1A shows a diagrammatic view of a detection device 100 and its components, the processing module 101, the antenna 102 and an output 103, which are all coupled together to provide signal communication therebetween. In an example, the detection device 100 is a handheld device for ease of moving the detection device where it is needed for a search and rescue operation or an interdiction (e.g., border patrol) operation. The handheld size allows a person to move the detector 100 such that the detector can operate as a passive synthetic aperture radar-type device. The processing module 101 includes hardware, e.g., circuitry, which can execute instructions and can be stored in the module 101. Parts of the hardware can be adapted to process signals or parts of signals, e.g., radio frequency signals, solely in hardware. The processing module 101 can further include dedicated task sub-modules or components, e.g., a digital signal processor, an analog signal processor, a navigational position processor, memory, display, communication, and filters. Examples of digital signal processors that can be used in the processing module include Blackfin, SHARC, SigmaDSP, TigerSHARC, and ADSP-21xx, all by Analog Devices of Norwood, Mass. The processing module can also be a digital signal processor manufactured by Freescale Semiconductor of Austin, Tex. The processing module 101 can include a global navigation unit, e.g., global navigation satellite system (GNSS). The global navigation unit includes a small electronic receiver that determines its location (longitude, latitude, and altitude) to within a few meters or less using time signals transmitted along a line-of-sight by radio signals from satellites. The receivers can calculate the precise time as well as position of the detection device 100. The position information can be used in determining location and type of a target 104, e.g. a vehicle. Examples, of GNSS include United States' NAVSTAR Global Positioning System, the Russian's GLONASS, the European Union's Galileo positioning system, the People's Republic of China's regional Beidou navigation system. The processing module 101 can further include wireless communication units such as WiFi, cellular telephone, Bluetooth, or encrypted Zigbee communication devices. The processing module 101 can include communication device that communicate over various standards, e.g., IEEE 802.15, 802.16, mesh networks, etc.

The processing module 101 is configured to execute instructions that are stored in physical media and readable by an electronic device. The processing module 101 includes a memory to store the instructions. The instructions can include signal filtering instructions, comparison instructions that compare a received signal versus known, stored signals, signal processing instructions to determine location of a signal source, terrain correction functions, vehicle travel path determination instructions, among other functions that can be programmed as instructions. Instructions can be stored in physical media and transmitted in physical media that allows a signal with information to be transmitted from one physical location to a second physical location. Instructions can be executed by a machine. In an example, the processing module 101 provides a compass function to determine to with one degree or less the direction the detection device is pointing.

The antenna 102 is electrically coupled with the processing module 101. The antenna 102 senses broadcast electrical signals and communicates the signals to the processor 101. In an example, antenna 102 is a directional antenna, such as an HB9CV-type antenna. In an example, the antenna 102 is a YAGI-type antenna. The antenna 102 is shown as a single unit in FIG. 1 however, the antenna can include a plurality of antenna modules that are tuned to specific frequencies to provide gain at those frequencies to aid in detection of vehicles. Examples of specific frequency ranges can include 120 MHz-123 Mhz, about 145 Mhz-148 Mhz, about 155 Mhz-158 Mhz, about 215 Mhz-218 Mhz, about 242 Mhz-245 Mhz, and 400 Mhz-900 Mhz. In a further example the antenna can be tuned to one of the following signal bands for sensing: SAR Civilian (aviation band and 406 beacon band), CSAR Military, 136-150 MHz, 150-162 MHz, 160-174 MHz, 136-174 MHz, 212-220 MHz, 380-450 MHz, or 450-512 MHz.

In an example, the antenna 102 includes a central spine, which can house the electrical connections and some of the circuitry of the antenna assembly, and at least one ½λ conductor at an end of the spine. In an example, ½λ conductors are at both ends of the housing. In an example, there are two antenna rods extending from each side of the central spine. In an example, the antenna rods are cross coupled front to back in the spine. The antenna spine can act as a housing that can enclose and support electronic circuits with active or passive elements to tune the antenna to a specific frequency band. The electronic circuits of the antenna can be designed to provide a high gain for only the frequency band to which each antenna is tuned. Once specific stray emission signal profiles for certain vehicles are determined, then antennas can be designed to provide high gain reception at the specific frequencies of the stray emission signal of interest. The antenna 102 can be mechanically fixed to the processing module 101. In another example, the antenna 102 is removably connected to the processing module 101 so that different antennas can be used with a single processing module 101. In an example, the antenna 102 can identify itself to the processing module 101 such that the processing module applies appropriate instructions to the sensed signals. The antenna 102 tuned for a specific frequency can be selectively connected to the processing module 101. In an example, the antenna 102 can identify itself to the processing module 101 such that the processing module applies appropriate instructions to the sensed signals.

The display 103 includes a liquid crystal display that receives display data from the processing module 101. The processing module 101 can produce display signals representing the received signals, filtered signals, virtual compass representations, text, distance indications, and other icons representing functionality of the detection device 100. The display signals shown on display 103 can include topographical maps and location of a sensed target on the topographical map. The display is hardened for filed use and, in an example, hardened to military specifications.

The detection device 100 can include a weather proof housing enclosing the processing module 101 and display 103 or just the processing module 101. In a handheld configuration the display remains visible. In an install and leave at a post, the housing encloses the processing module and display to protect same from the weather.

In an example, the detection device 100 is designed to passively receive RF signals, e.g., stray emissions from targets, e.g., vehicles and electronic circuitry. Detection device 101 does not emit an excitation signal to force a part of the target to re-emit a signal or to receive a reflection of an excitation signal.

Target, e.g., a vehicle or electronic signal producer, 104 can include a mechanism that produces and unintentionally transmits electromagnetic radiation. Many electronic devices and circuits emit some signature electromagnetic radiation. Most vehicles that use electricity in some form are very noisy in parts of the radio frequency spectrum. The present inventor recognized this property of vehicles, e.g., aircraft and boat motors, and developed the structures and methods described herein to capitalize on such properties. The present inventor recognized this property of some electronic and electrical devices, e.g., radio transceivers, radio emitters, circuits that form part of device, etc. Moreover, the present inventor recognized that types of motors, vehicles, aircraft, and boats would have unique radio frequency signature that could be stored in detector structures described herein. A detector, as described herein, can passively sense these stray signals, filter the unique signal from background noise, identify the target, e.g., a vehicle, based at least in part of the stray signal, and locate the position of the target also based at least in part on the stray signal. The present inventor further recognized that specifically tuned antennas with interpretation hardware and instructions allow a user to identify the position of the identified emitter. In an example, the position of a detected target can be with a few meters at distances up to about 100 kilometers.

In an example, the stray radiation can include a detectable signal, for example, a periodic signal. The periodic signal could be in the range of 120 MHz to about 500 Mhz. The periodic signal would have a unique spectral profile that repeats itself and, hence, would be detectable over time. In an example, internal combustion engines use spark plug wires that transmit a high voltage pulse to the spark plugs that in turn spark within the cylinder to ignite fuel to drive the piston. Obviously, this repeats for each spark generated. Spark plug wires consist of a conductor, usually, copper, surrounded by an insulator layer, e.g., thick silicone outer sheaths. The conductor is selected to conduct a pulse of high voltage, which can be in the range of 10,000 volts to 50,000 volts. A voltage step-up device, e.g., a coil or a solid state device, takes the vehicle operating voltage, e.g., 6, 12, 13.5, or 16 volts or in any range between these voltages and steps the voltage up to by orders of magnitude to trigger the fuel ignition spark. The spark plug wires can vary in length from a few inches to over a yard or meter. In an example, the wires range from about 10 inches to about 39 inches, +/−0.5 inch. Another source of a stray emission is the coil wire. Each of these wires can act as a radio frequency antenna, e.g., a half wave dipole.

The use of low-flying small aircraft, e.g., ultralights and other amateur-built aircraft, is known to be part of illegal border crossings and drug trafficking. These aircraft fly slow (less than 150 knots or less than 50 knots) and low (less than 5,000 feet or less than 1,000 feet). In an example, such aircraft include a single seat or a dual seat. The aircraft typically has an aluminum open frame with a fabric wing. The engines can be manufactured by Rotax, GmbH of Gunskrichen, Austria. These motors can emit the stray radio signals. Motors can be two, four, or in some cases, six cylinders. The payload carried by such aircraft can range about 200-400 pounds plus the weight of the pilot. When used for drug smuggling, the street value of some drugs can be $200,000-$500,000 for marijuana or at least $10 million of cocaine per flight can be flown into the US using small aircraft.

The use of this type of aircraft can also be used to aid in its detection using the structures and methods described herein. The motors for this type of aircraft are in the open and, hence, less shielded than other types of aircraft. The spark plug wires or leads carry a high voltage to the spark plugs. Moreover, there can be two spark plugs per cylinder. As described above, the spark plug leads act an antenna. The leads have a length that produces a specific frequency. The motor is design with specific requirements to properly spark the fuel in the cylinder. In an example, the pulse rate of the high voltage on the lead creates a signature at a specific motor speed. While generally speaking more leads provide a more distinct stray emission signal, this is due to a greater number of spark plug leads. The motors for ultralights include two spark plugs per cylinder for safety. This results in dual spark plug leads that must carry the high voltage to the spark plug at essentially the same time and at essentially the same power. However, the spark plug leads will be of slightly different length and produce a stray emission at two frequencies that pulse at the same rate. Moreover, the amplitude of these signals can be essentially the same. The present detector can sense and identify these signals.

In a specific example, the specifications for a lightweight aircraft motor are 80-100 hp output, 4 cycle motor at 4000 RPM, which produce 100 cycles per sec per spark plug lead with a pulse width of about 1 millisecond at about a 10% duty cycle and about 10 milliwatt/sec. In the known range of the spark plug leads the 100 milliwatt signal will be broadcast in a range of about 120 MHz-123 Mhz. In this example, the antenna will be tuned to sense this narrow band. The processing module will process this band of received signal, filter the background noise, and detect a known stray emission signal from the aircraft.

FIG. 1B is a block diagram showing a detector device processing module 101, in accordance with an example embodiment. The processing module 101 can include, in some example embodiments, a data communication module 122, a data interpreting module 124, an analysis performing module 126, a report generator module 128, and the database 129. The operations of the modules and the processing module 101 are explained in more detail within the context of an example method(s) for vehicle detection and location as described herein. The modules 122, 124, and 128 can include both hardware and instructions to be executed on the specific hardware. The database 129 can store sensed data, instructions, signal template data, and other instructions need for operation of the present device on a tangible media or other physical construct. Generally, the data communication module 122 can facilitate communication between the other modules and the database. The communication module 122 can further provide a communication link to other electronic devices and to people. The data interpreting module 124 can act to determine whether a known stray emission signature has received. The analysis performing module 126 can apply position determining algorithms to the detected stray emission to determine its range and angular position. The analysis performing module 126 operates to locate the Line of Bearing (LOB) of a signal from a known frequency or frequency band. The analysis performing module 126 can also apply topographical algorithms to correct for land effects on the sensed signal. The report generating module 128 can generate useful reports for display to a user or for transmission to other electronic devices.

The database 129 can further store topological data that can be used in the signal processing by analysis module 126. The topological data can be elevational data for the terrain and also other geographic data, e.g., water features, type of soil, type of stone, type of vegetation. The terrain data can be downloaded from various sources, e.g., from the U.S. Geological Survey and stored in memory on the device 100. The processing module 101 can use the topological/terrain data to filter the data being sensed. For example, the processing module 101 can remove sharp edges from the sensed data as floes positives and can remove reflections from the terrain.

The processing module 101 takes in passively sensed data from the antenna 102 and performs a highest probability analysis on the data relative to the stored templates of targets. In an example, the processing module 101 counts the data points and then matches these counts to stored templates. The processing module 101 outputs a probability match. As more data points are sensed, the processing module 101 continues to compare the sensed data to the stored target templates. The processing module 101 outputs a probability match data, which can indicate a low likelihood of a match to a perfect match.

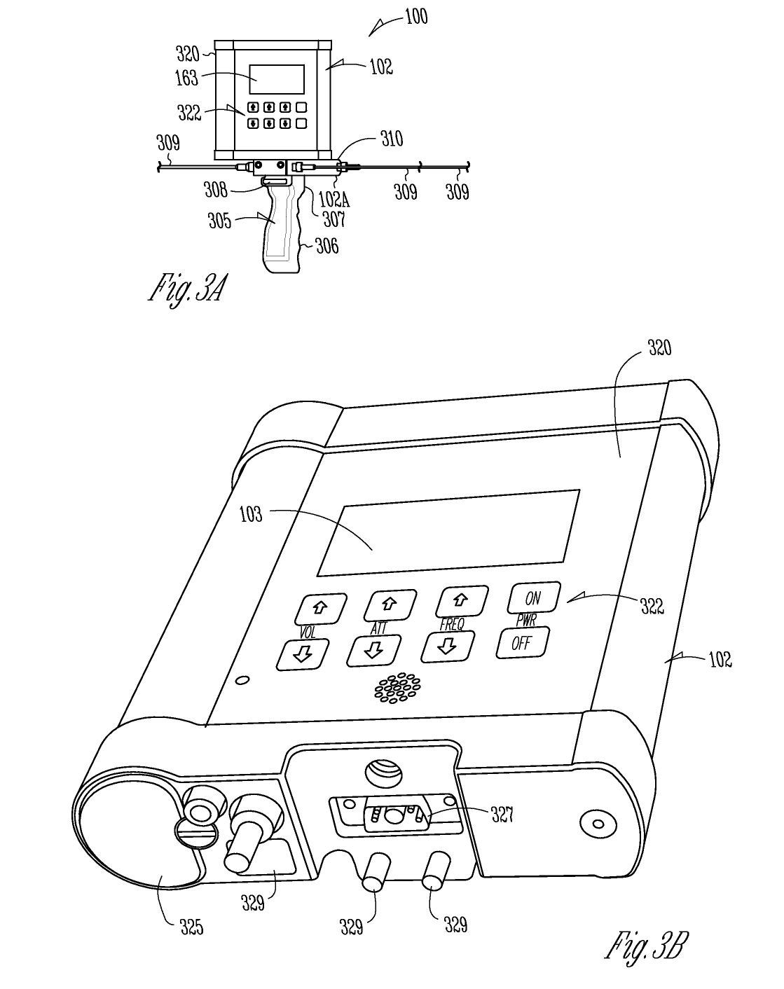

FIG. 2 shows a diagrammatic representation of an example form of an electronic computing device 200 within which a set of instructions can be executed causing the machine to perform any one or more of the methods, processes, operations, applications, or methodologies discussed herein. The computing device 200 can include the functionality of at least one detection device 100 as described herein. Other electronic devices described herein can include one or more components of the computing device 200.

In an example embodiment, the device 200 operates as a standalone machine or can be connected (e.g., networked) to other machines. In a networked deployment, the machine 200 may operate in the capacity of a server or a client machine in server-client network environment, or as a peer machine in a peer-to-peer (or distributed) network environment. The other machines that can network with the device 200 can include a server computer, a client computer, a personal computer (PC), a tablet PC, a Personal Digital Assistant (PDA), a cellular telephone, a web appliance, a network router, switch or bridge, or any machine capable of executing a set of instructions (sequential or otherwise) that exchange electronic or optical data with the detector 100 and can specify actions to be taken by detector 100 or can act as a relay between the detector 100 and other detectors or base stations. Further, while only a single machine 200 is illustrated, the term “machine” shall also be taken to include any collection of machines that individually or jointly execute a set (or multiple sets) of instructions to perform any one or more of the methodologies discussed herein.

The example computing device 200 includes a processor 202 (e.g., a digital signal processor (DSP), an analog signal processor, a central processing unit (CPU), a graphics processing unit (GPU) or both) and a main memory 204, which communicate with each other via a bus 208. A positioning system 206 is provided. Positioning system can include a position navigation satellite system, e.g., the Global Positioning System (GPS), other satellite-based positioning system, or a cellular triangulation system to determine location of the device 200. The computing device 200 can further include a video display unit 210 (e.g., a liquid crystal display (LCD), plasma display, or a cathode ray tube (CRT)). The computing device 200 can also include user input devices, such as an optional alpha-numeric input device 212 (e.g., a keyboard) and a tactile input device 214 (e.g., push buttons, switches, and the like).

A drive unit 216 includes a machine-readable medium 222 on which is stored one or more sets of instructions 224 (e.g., software on a physical media or communication channel) embodying any one or more of the methodologies or functions described herein. The instructions 224 can also reside, completely or at least partially, within the main memory 204 and/or within the processor 202 during execution thereof by the computing device 200. The main memory 204 and the processor 202 can further comprise machine-readable media.

The instructions 224 can further be transmitted or received over a network 226 via the network interface device 220. While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the device and that cause the device to perform any one or more of the methodologies shown in the various embodiments of the present invention, including passive detection of stray (e.g., unintended) radio frequency that can be used to identify the source of the stray signal. The term “machine-readable medium” shall accordingly be taken to include, but not be limited to, solid-state memories and optical and magnetic media, and physical carrier constructs.

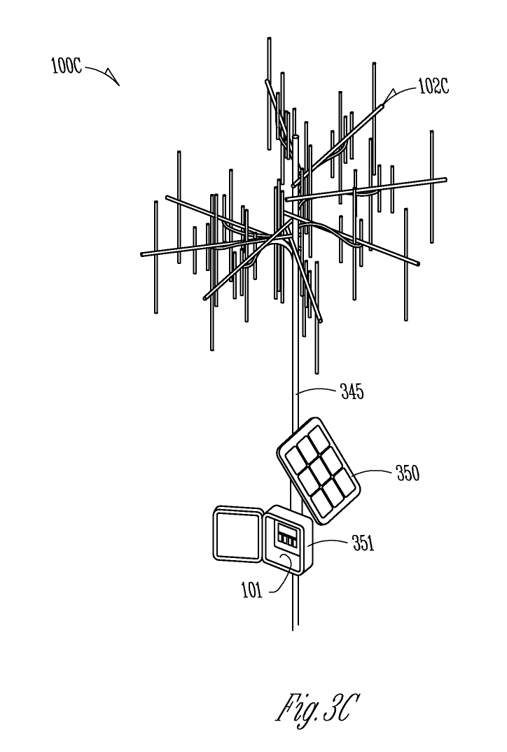

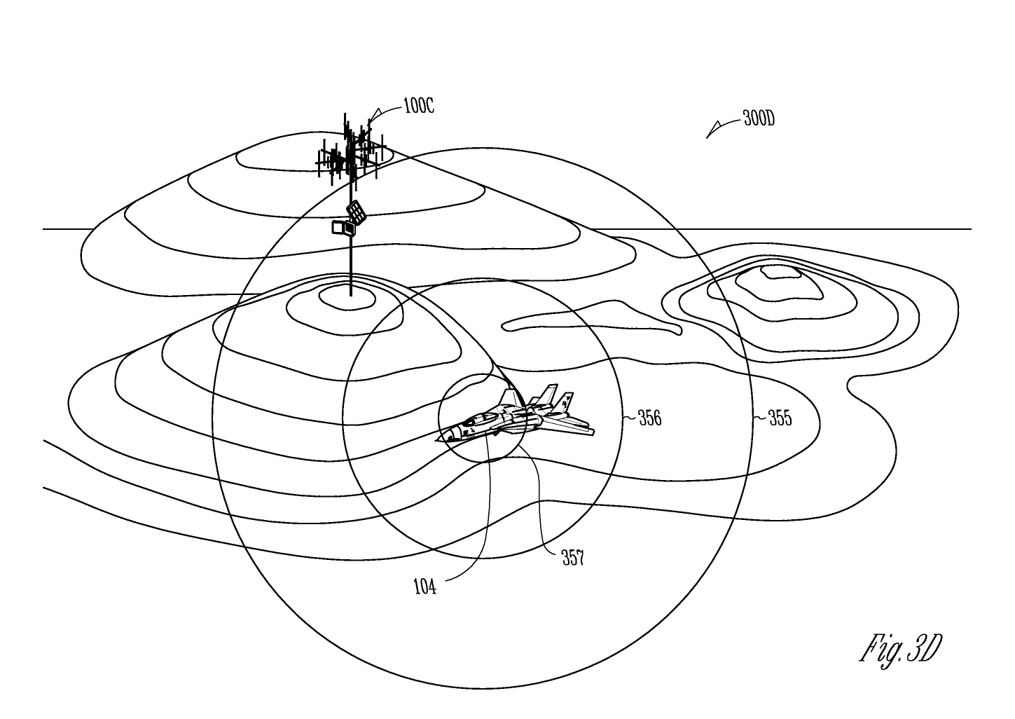

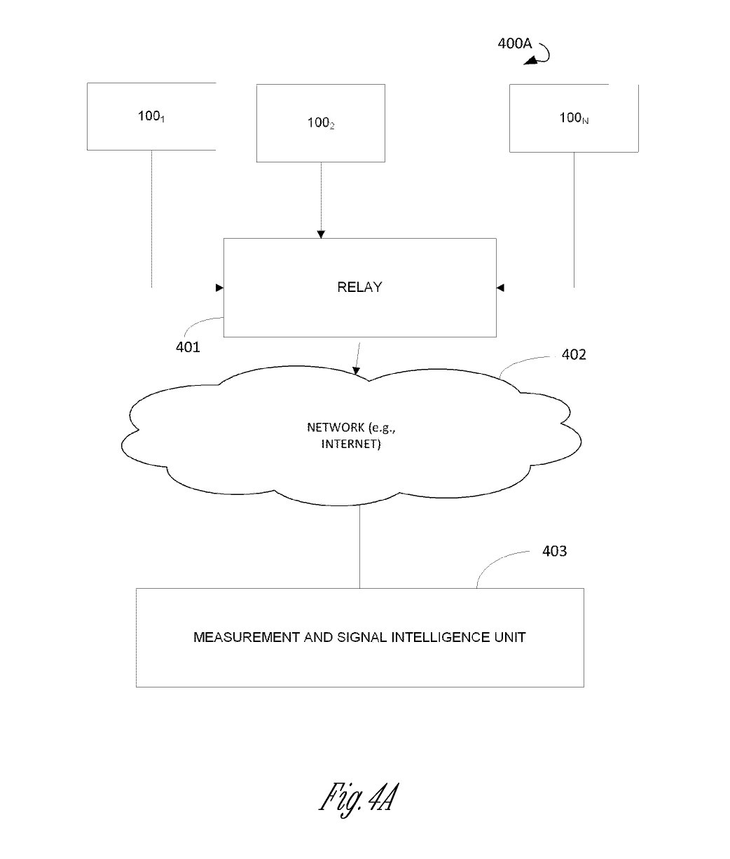

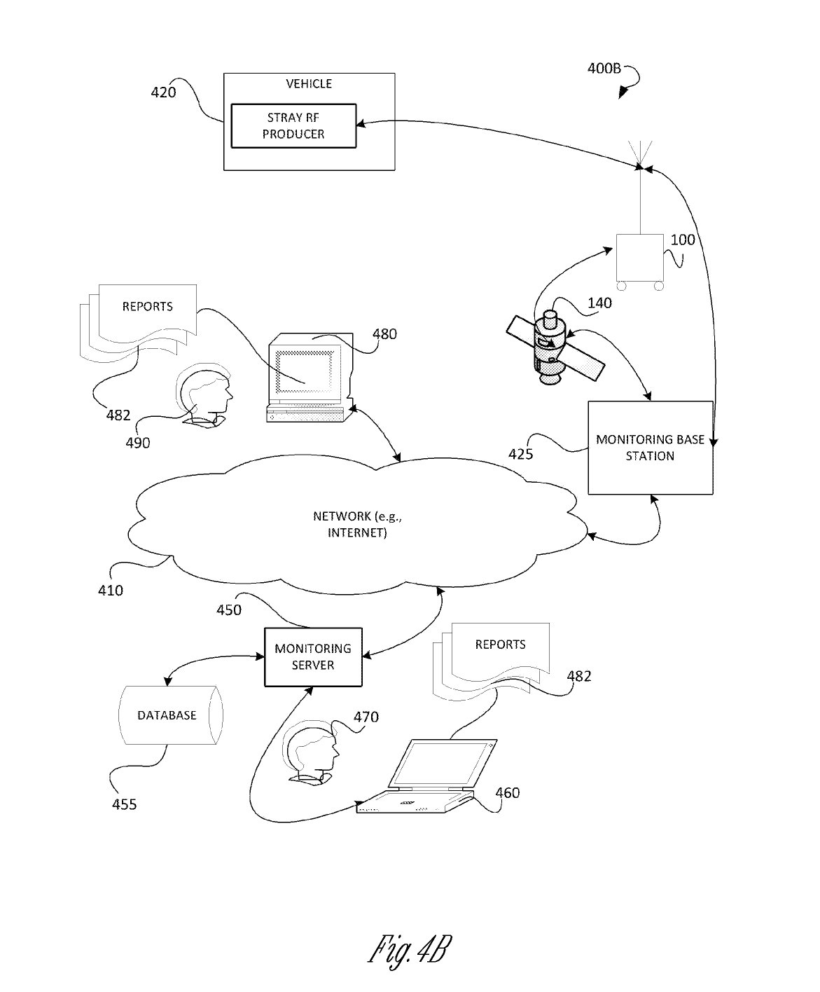

FIG. 3A is rear perspective view of a handheld detection device 100 according to an embodiment of the present invention. Detection device 100 includes a handgrip 305 in addition to the processing module 101, the antenna assembly 102A, and the display 103. The handgrip 305 acts as a base on which the antenna assembly 102A is attached. The antenna assembly 102A can be fixed to handgrip 305. The handgrip 305 includes a downwardly extending portion 306 that is shaped to engage a person's hand. In this example, a person can hold and manipulate using a hand and arm the detection device 100 to sense signals. A top 307 includes connectors that secure the handgrip 305 to the antenna assembly 102A. A level 308 is positioned on the back of the handgrip 305 to indicate that the user is holding the detector device 100 level. While shown with the ½-λ conductors 309 extending outwardly from the center spine 310 of the antenna assembly 102A.

The center spine housing 310 is secured on the handgrip 305. The housing 310 can be removed from the handgrip and from the processing module 101 to change the antenna assembly 102A to another antenna assembly. The housing 310 can include therein circuitry, with passive elements and active elements, which can tune the antenna to specific frequencies and focus the sensing beam path of the antenna assembly 102A. Examples of antenna circuitry can include radio frequency filters. Examples of specific frequency ranges that the antenna assembly 102A are tuned can include 120 MHz-123 Mhz, about 145 Mhz-148 Mhz, about 155 Mhz-158 Mhz, about 215 Mhz-218 Mhz, about 242 Mhz-245 Mhz, and 400 Mhz-900 Mhz. In an example, the antenna assembly 102A includes at least one ½-λ conductor 309 extending outwardly from at an end of the housing 310. In an example, ½-λ conductors 309 are at both ends of the housing 310. In an example, the ½-λ conductors 309 are foldable against the sides of the housing 310. In an example, the ½-λ conductors 309 are removably secured to the sides of the housing 310. The device 100 can have a width of about 32 inches with 14 inch antenna conductors 309. In an example, the device 100 weighs less than about six pounds for handheld use.

The processor module 101 is removably fixed to the antenna center spine 310 using mechanical and electrical connectors. The processing module 101 includes a weather resistant housing 320 through which the display 103 is visible to the user holding the handgrip. A plurality of user inputs 322 and interfaces are provided. The inputs 322 can include volume control buttons, attention buttons, frequency control buttons, and power buttons. In an example, the processing module 101 includes a speaker that can indicate when vehicles are detected or attention, e.g., for required inputs, of the user. The processing module 101 is configured to process sensed signals from the antenna assembly 102A to locate the position of an emitter of radio frequency signals, which can be used for rescue, interdiction, border patrol, or other identification and analysis.

FIG. 3B is bottom perspective view of the processing module 101 according to an embodiment of the present invention. The display 103 is visible through an aperture in the housing 320. A battery enclosure 325 is visible on the bottom of the housing 320 in which a battery is housed to power the detection device 100. Electrical signal connectors 327 are provided to connect to the antenna to receive sensed signals from the antenna. Mechanical connectors 329 extend from the bottom of the housing 320 to fix the housing to either the antenna 102 or the handgrip 305.

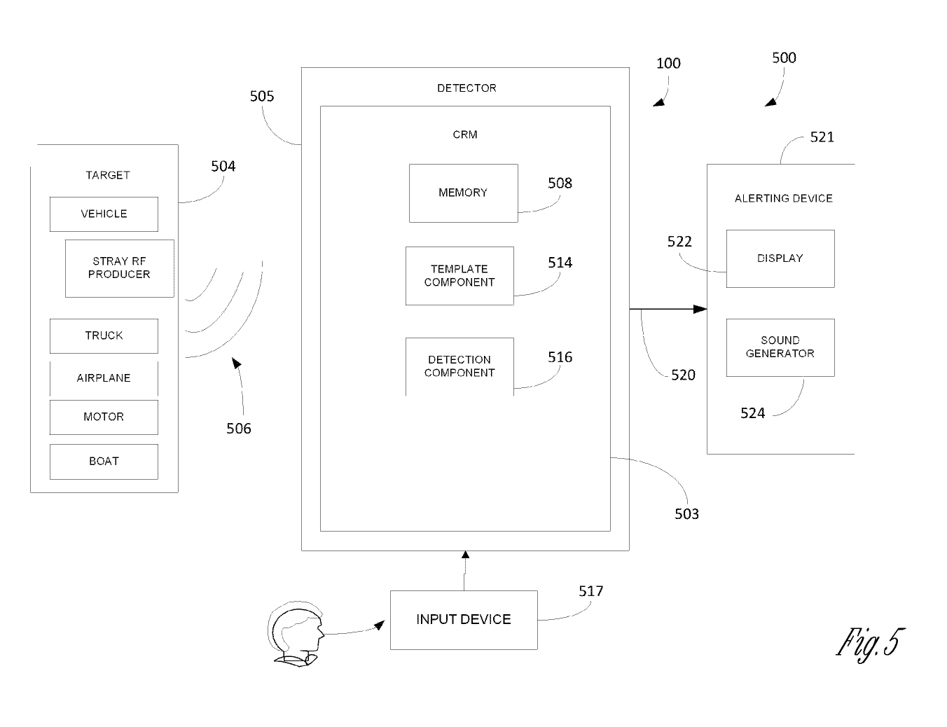

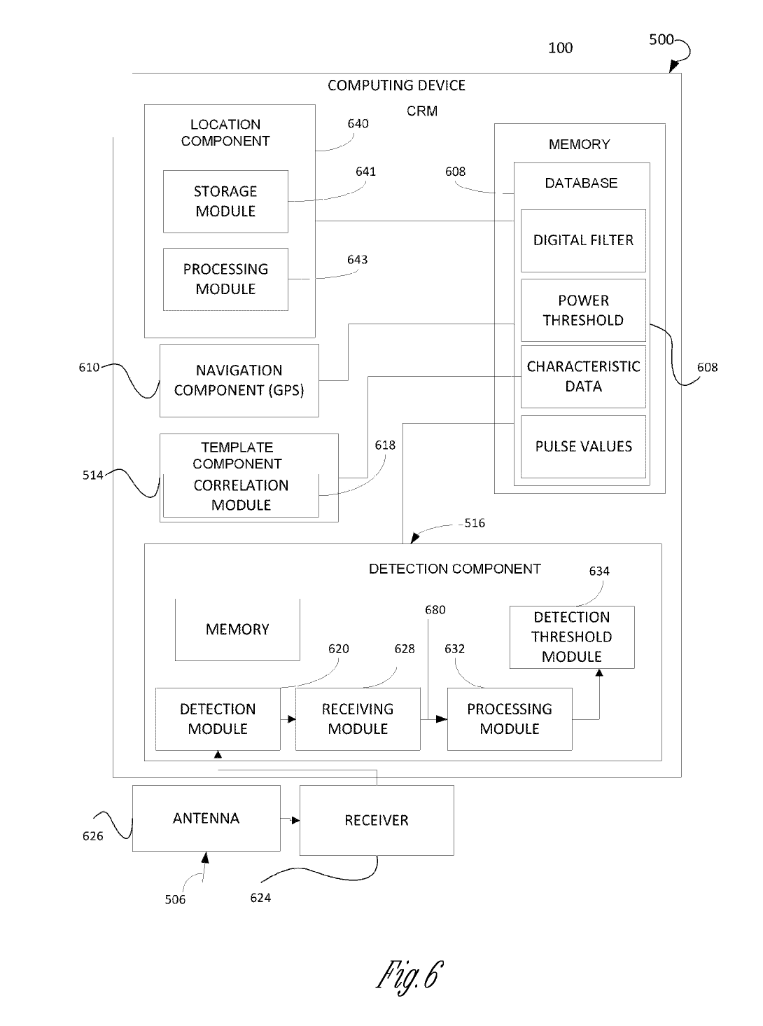

FIG. 3C is perspective view of a detection device 100C according to an embodiment of the present invention. The detection device 100C is similar to the other detection device embodiments described herein with a few modifications. The detection device 100C is designed to be installed and operate autonomously without a human operator present at the device. A stanchion 345 is fixed in place at a location for whereat detection of vehicles is desired. An antenna array 102C is fixed near the top of the stanchion 345. The array 102C can include a plurality of antenna 102 as described herein, with an antenna for each frequency of interest. The frequency of interest is the frequency at which a target vehicle is known to emit stray signals. The antenna assembly 102C can include a plurality of antenna focused to sense at individual frequencies all aligned in a particular direction at a probable direction whereat a target vehicle is expected to travel. A weather resistance housing 351, shown with the door open to see the processing module 101, encloses the processing module 101. The processing module 101 is connected to each of the antennas in the antenna assembly 102C and can process the sensed signals from each of the antennas in the array 102C. The processing module 101 is adapted to send report signals to remote receives, such as a relay 401, another detection device 100, a network, a measurement and signature intelligence unit 403, monitoring base station 425 (See FIGS. 4A and 4B for examples), among other devices. As the stanchion 345 can be positioned remote from power sources, a solar panel 350 is mounted to the stanchion 345. The solar panel 350 collects sunlight and coverts it into electrical energy to power the panel module 101 or charge a battery to power the panel module 101.

FIG. 3D is diagrammatic view 300D of a detection device 100C in use according to an embodiment of the present invention. A vehicle 104 is shown as an ultralight aircraft flying over a terrain. The ultralight 104 unintentionally emits periodic radio frequency signals 355, 356, 357. The pulsed signals 355, 356, 357 are at a frequency that can be detected by detection device 100C. The detection device 100C is positioned on relatively high ground in an attempt to remove ground effects on the signals it can sense. The antenna is designed to sense the frequency of the signals 355, 356, 357. The antenna provides the sensed signal to the processing module 101 that in turn identifies the signals 355, 356, 357 as those that are stray, unique emissions from a specific vehicle, here shown as ultralight 104. The processing module can further determine the location, e.g., the distance and angular position of the vehicle. The detection device 100C can further apply the topological data to the sensed signals to correct for reading from the background or the topological data. The processing module 101 can determine the angular position of the vehicle to within one degree. The processing module 101 can further determine the distance from the detection device 101. In an example, the change in power of the sensed signal can be used to determine distance. The antenna is tuned to a narrow band and when the signal is sensed the angular position is within a one degree band. The processing module 101 can determine the angular position of the vehicle to within a meter or a few meters. The processing module 101 can transmit a target identified signal to a further device and to authorities.

It will be recognized that the vehicle 104 can be another type of vehicle, e.g., a ground based vehicle, such as a truck, automobile, motorcycle, all-terrain vehicle, military vehicle, marine vehicle, ship, boat, among others. Motor vehicles based on their motors, e.g., mechanical and electrical components, produce an identifiable repeating signal that can be sensed and identified. Similar processes can be used to passively identify targets other than vehicles.

The terrain data can be used in the processing module 101 to correct for the effects of the terrain on the sensed signals. In the example, shown in FIG. 3D, the terrain includes three elevational features. The detection device 101C is positioned on the top of one of the elevations. However, the other two elevations may reflect the stray emissions from the aircraft 104. The processing module 104 can use the reflected signals to determine if a target aircraft is in the area. However, the reflected signals, if any, must be filtered from or corrected for when determining the target aircraft location. The detection device 101C locates the line of bearing of a signal from a known frequency or frequency band from the aircraft 104 and determines the angle of inclination.

FIG. 4A is diagrammatic view of a detection system 400A according to an embodiment of the present invention. A plurality of detection devices 100₁, 100₂, . . . 100_{N} that each can operate to sense vehicles according to the teachings herein. The detection devices 100₁, 100₂, . . . 100_{N} report their signal gathering data to a relay 401. The relay 401 can then send the data through a network 402 to a measurement and signature intelligence unit 403. Relay 401 can be an airborne receiver and re-transmitter housed in an aircraft, such as a plane, a helicopter, lighter-than-air craft, etc. or positioned on the ground. In an example, the relay 401 is part of a mobile phone communication network, either voice channels or data channels. The network 402 can be a global computer network, such as the internet, a local area network, a private communication network, cellular network, etc. The measurement and signature intelligence unit 403 can include a plurality of processors and memories to store data and instructions to be executed by the processors. The measurement and signature intelligence unit 403 can process all of the data from the detection devices 101 to confirm identified vehicles. Unit 403 can apply further signal processing techniques to identify potential vehicle targets and identify the location of vehicles. In an example, the unit 403 can have greater processing power than the detection device and, hence, can apply more processing intensive algorithms to identify targets. The measurement and signature intelligence unit 403 can further operate to reposition the detection devices 100 to emphasize coverage in the area where more target vehicles are detected. The measurement and signature intelligence unit 403 can further take into account the population centers, road systems, and other topographical features when processing the data from the detection devices 100. The measurement and signature intelligence unit 403 can derive additional data using collected, processed, and analyzed data from the detection devices with other third source data. The measurement and signature intelligence unit 403 can produce intelligence that detects and classifies targets, and identifies or describes signatures (distinctive characteristics) of fixed or dynamic targets (vehicles). Use of the measurement and signature intelligence unit 403 can be particularly effective when the detection devices 100 are automated and unattended.

FIG. 4B illustrates an example environment 400B, within which vehicle asset information reporting can be implemented. As shown in FIG. 1, the example environment 400B comprises a vehicle 420 (e.g., an aircraft, plane, ultra-light, etc.), which emits an electronic signature from emitter 421. In an example, the emitter 421 unintentionally produces stray radio frequency signals. The detector 100 can perform at least one of passively sensing, receiving, collecting, storing, processing the stray RF signal of the vehicle 420. The detector 100 can further transmit various information related to at least one of identification data, position data and operation data of the vehicle 420 to a monitoring system 425. The detection device 100 can integrate an RF sensor, a GPS transceiver, cellular/satellite transceiver, local wireless technology, and/or various computing technologies into a single mobile detection system. In another example, the detection device 100 is a small device that is fixed for at least a short time, e.g., hours, days, or weeks, in a single location. The detection device 100 senses and identifies the vehicle, e.g., an aircraft. The detection device 100 can further determine the position and send position coordinates, such as GPS data coordinates, sensor data/events, processed data, and messages from the device 100 to a monitoring base station 425.

Base station 425 can receive data from a plurality of detection devices 100. Base station 425 can run software (execute stored instructions on an electronic processor) specifically designed to process this type of information. The software can apply heuristics, adaptive resonance, and topographical clarification techniques to the data from the detection devices 100. The base station 425 can process information and make decisions on intelligent reporting of data that is to be collected and reported. In an example, the base station 425 can apply measurement and signature intelligence techniques to the data from the detection device to provide a more holistic or complete view of the area under surveillance by the detection device(s) 100.

A satellite network 140 can provide a communication link between the detection device(s) 100 and the monitoring base station 425 and, optionally, provide further data to the monitoring base station 425 (or to the server 450). In an example, the network 140 can communicate over the IRIDIUM™ satellite communication system. Additional data can be imaging data, either real-time of previously imaged data. Additional data from the satellite network 140 can provide additional positional and operational data relative to the vehicle 420. The satellite network 140 can focus, e.g., narrow, it surveillance to a specific area identified as of interest by either the detection device 100 identifying a likely target in the area based on the target's stray signal signature. While described as satellite system 140 other high-flying aircraft with sensing equipment can also be used. However, the sensing of the satellite and the high flying aircraft cannot efficiently detect low flying vehicles such as ultra-lights and small aircraft.

A further server 450 can be communicatively coupled through a communication network 110 to the monitoring base station 425 and/or the detection devices 100. The server 450 can be utilized to access and pull the positional and operational data and operational data associated with the asset 100 via the network 110, which can be an open architecture interface (Internet) or a closed communication system. Various communication protocols (e.g., Web Services) can be utilized in the communications occurring between the server 450 and the monitoring base station 425. The base station 425 can utilize telematics and intelligent data processing as well as software to make the information available via the network 410 to the server 450 or to responder units 470.

While illustrated as two separated systems, in an example, the base station 425 and the monitoring server 450 can be integrated and communication between the two systems occur as the vehicle is being monitored by the detection device 100.

The monitoring server 450 can be communicatively coupled to a database 455, in which the base station 450 may periodically store results after processing of the information received from either the base station 425 or the detection device 100.

The monitoring server 450 is optionally associated with an operator 470 operating the monitoring server 4500 via a computer 460. The computer 460 can include a Graphical User Interface (GUI) facilitating display and manipulation of the monitoring server 450. The computer 460 can also enable the operator 470 to view and manipulate reports 482 that can be used to manage and monitor one or more of the data from the detection device(s) 100. The operator 470 can receive real-time reports related to the vehicle detection and notify an intercept unit or response unit 490, e.g. over a communication network 410. Using detailed map views shown on any of the detection device 100, the computer 460 or the computing device 480, an authorized user can see up-to-date data related to location of the vehicle 420.

Data communication as described in FIGS. 4A and 4B couples the various devices together. The network 410 is preferably the Internet, but can be any network capable of communicating data between devices can be used with the present system. In addition to the Internet, suitable networks can also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications can also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digit® networking.

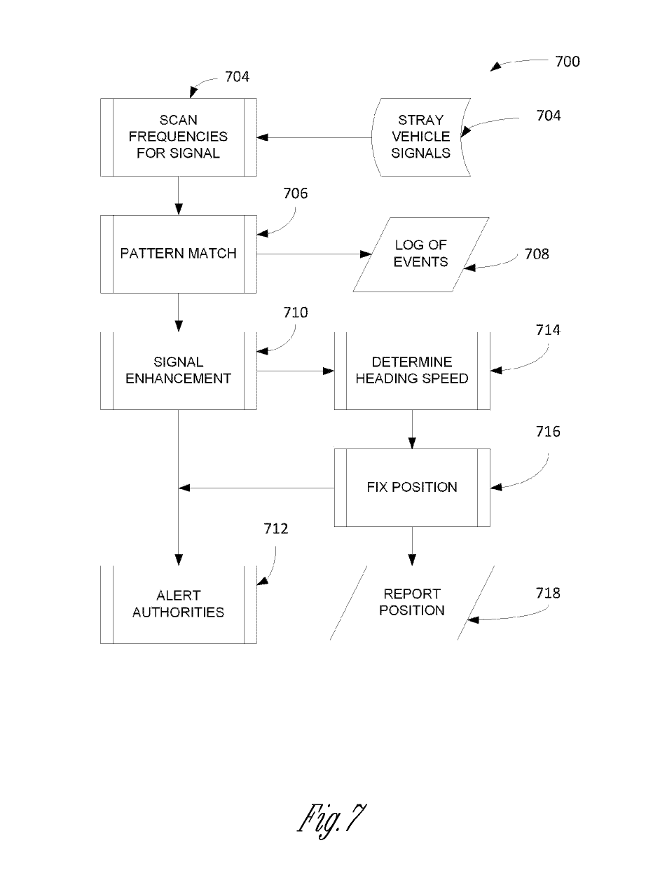

FIG. 5 shows a further diagrammatic view of a system 500, which can include the detection device 100. The device 100 can include a specific computing device 505 adapted to execute instructions to sense signals and identify targets e.g., vehicles, aircraft, as described herein. The computing device 505 includes a computer readable media 503, which can include at least one of volatile and non-volatile media, removable storage media, non-removable storage media and any other physical structure, all of which can store computer readable instructions, data structures, program modules or other data.

A vehicle 504, such as an aircraft, includes an emitter, e.g., and engine, turbine or other device, that unintentionally emits stray electrical signal, e.g., electromagnetic emission, 506. The detection device 100 can detect the presence and location of the vehicle 504 using its stray emission 506. Electrical signal 506 can be unique for any specific type of vehicle 504. In an example, the signal 506 for a given vehicle (or a given motor) can be periodic and have a consistently shaped waveform in the time and frequency domains.

FIG. 5 further diagrammatically shows components of the computing device 505. Unique signal signatures and templates of stray electrical radiation are stored in the memory 508. In controlled environments, e.g., the one described in Detection and Identification of Vehicles Based on Their Unintended Electronic Electromagnetic Emissions, Dong et al., IEEE Transactions on Electromagnetic Compatibility, Vol. 48, No. 4, November 2006, hereby incorporated by reference, in its entirety, for any purpose, classification and analysis of desired target vehicles is performed. If any material incorporated by reference conflicts with the present disclosure, the present disclosure controls the interpretation. Unique stray emissions are sensed and analyzed to produce a unique signature for that unique type of target, e.g., a vehicle. In an example, signals are stored and processed in both time and frequency domains. In an example relating to a vehicle, the emissions from the spark plug wires are analyzed and its unique signature is determined. Unique signatures from all desired types of targets, e.g., vehicles, specifically, aircraft, are determined and stored in memory 508. Key characteristics of the stray signal 506 can include the shape of the emission pulse, the rate of the emission pulse, and the frequency content of the emission pulse, and the frequency content of the signal over time. In addition, other factors such as atmospheric effects, temperature and ambient noise levels can alter the sensed stray emission 506. A template component 514 stores unique signatures of specific targets, e.g., vehicles and are stored in memory 508. Other templates for additional targets, such as electronic components, radio transmitters, receivers, beacons, emitters, etc. can also be determined and stored in memory 508 by the template component.

A detection component 516 responds to input received from an operator (e.g., a human user at the device 100, specifically in the case of a handheld device or a remote user, e.g., a server or other computing device remote from the detection device 100). Detection component 516 senses the stray emission 506. Detection component 516 can apply signal processing algorithms to the sensed data and compare the data to templates 514. When a match occurs, an alert signal 520 is provided to an alert device 521 to notify the operator that a target, e.g., a vehicle, has been identified. The alert device 521 can include a display 522 operatively coupled to the computing device 505 for providing a visual alert to the operator. The alert device 521 can also include a sound generator 524 operatively coupled to the computing device 505 for providing an audible alert to the operator. A specific visual indicator and/or specific audio signal can be provided for each specific target type. It will be understood that the alerting equipment can be integral with the detector 100, e.g., mounted on a circuit board. The alerting device 521 can also indicate the position of the target. In an example, the position includes latitude, longitude, and elevation. The position information can be within a meter or a few meters of the actual location of the target. In a further example, the position information is in a range distance, the circumferential angle and the elevational angle.

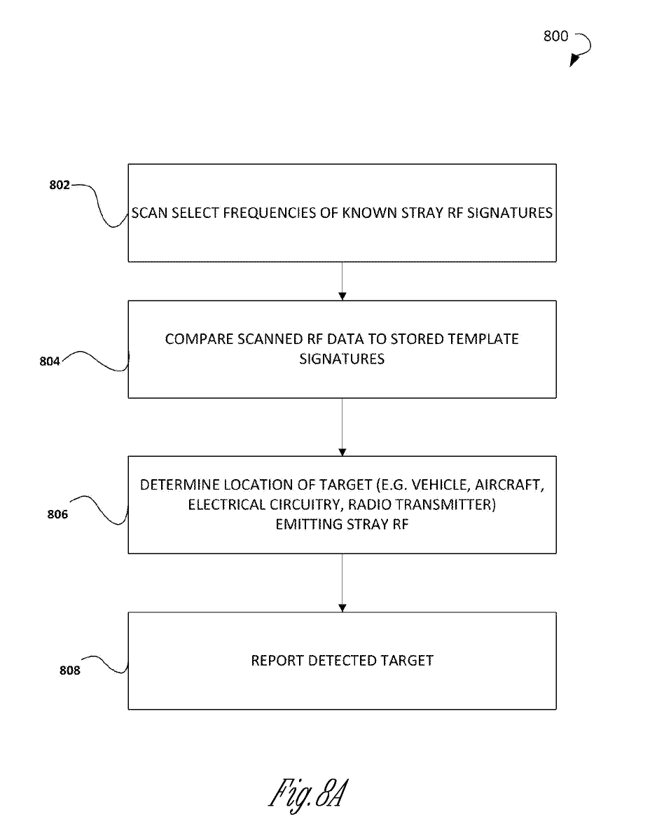

FIG. 6 shows a further diagrammatic view of system 500 including the detection component 516 that in turn includes one or more modules for facilitating the detection of the target vehicle. A detection module 620 is responsive to a detection command, which can be received from input device 517 (FIG. 5). Detection module 620 operates to identify stray emissions belonging to a target in the sensing area. The detection command can include detection instruction data and can be generated by an operator or from another computing device via the input 517. In an example, the detection device 100 can operate autonomously to generate the detection command 622. In an example, the detection instruction data can instruct the detection to search for a particle target's signal, e.g., when other devices 100 have detected similar targets, e.g., vehicles or when other data indicates that a certain target, e.g., a vehicle, is likely to be used.

A receiving module 628 of the detection component 516 is operatively coupled to the detection module 620 to receive the stray signal from the targete and measure same. The receiving module 628 digitizes the measured data to generate a digital measurement signal 680. A processing module 632 of the detection component 516 is operatively coupled to the receiving module 524 and processes the digital measurement signal 680. The processing module 632 can be executed on the computing device 505, which can include a digital signal processor. Processing the digital measurement signal 680 can involve retrieving a plurality of the sensed signal templates from a database 608 stored in memory.

The measurement signal 680 is correlated with the templates to determine if a target, e.g., a vehicle, is present in the sensing area. In an example, periodicity of the stray signal 506 can then be utilized to correlate it with a single square wave having repetition rate that matches the expected repetition rate found during classification and stored in the template. Many stray signals will vary relative to their specific emitters. For example, 4-cylinder engines may have a repetition rate that is different from a 6-cylinder engine. Dual (or multiple) spark plug leads per cylinder further provide a distinct stray signal. Amplitude of the signals may also vary in either the time domain of the frequency domain. Moreover, electronic components, e.g., local oscillators, will have different signals characteristics than other electronic components.

A detection threshold module 634, operatively coupled to the processing module 632, uses the information obtained from the processing module to compare the processed signal to a power threshold value. If the signal correlates to a known template and has a required power level, as determined by the detection threshold module 634, then the detection component 516 can indicate that a target has been identified by its stray signal.

Device 100 as shown in FIG. 6 further includes a navigational component 610 that can determine the location of the device based on received signals. Examples can include the GPS system, Galileo system and other known types of navigational positioning units.

A location component 640 is provided to process the received stray signal and determine the direction and location of the target of interest. Location component can look to the rate of change in the received stray signal. Location component 640 includes a memory module 641 and a processing module 643. Using algorithms the processing module 643 interprets the processed sensed stray signal and/or the raw sensed signal data, along with the directional data in the device 500, the position of the target is determined.

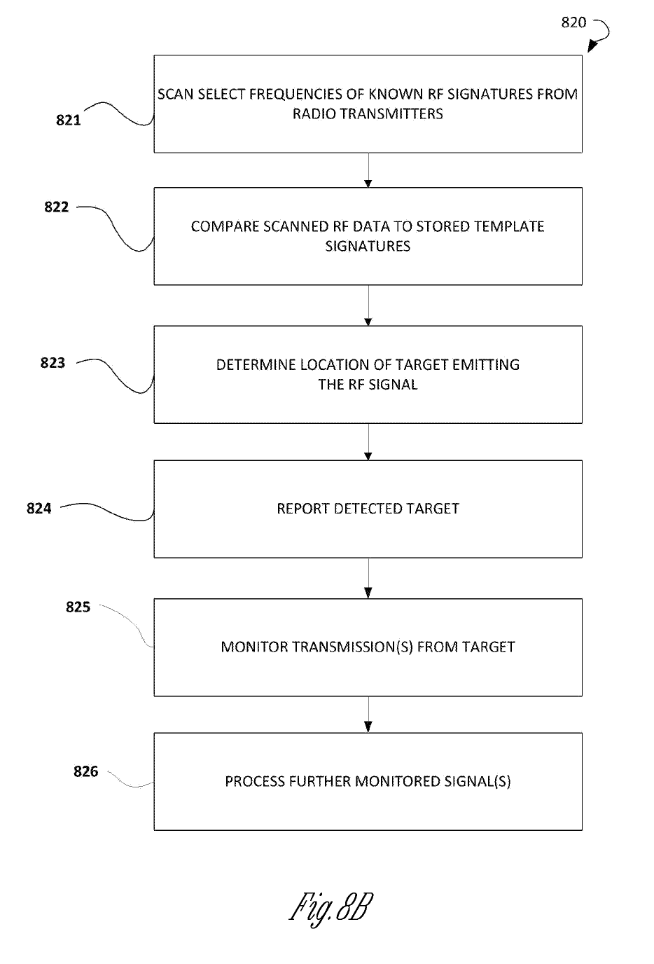

FIG. 7 shows a flow of the process 700 that can be performed by the detection device described herein or other structures with the same functionality. A database 702 is stored in a memory and includes samples of emission signals of targets. In an example, the sample of emission signals is created by testing and identifying unique RF stray signals. One example of a testing technique is described in Detection and Identification of Vehicles Based on Their Unintended Electronic Electromagnetic Emissions, Dong et al., IEEE Transactions on Electromagnetic Compatibility, Vol. 48, No. 4, November 2006. The unique signals for vehicles are stored in the memory of the detection device 100. At 704, scans are performed of ambient RF signals that can include the stray emission from a target, e.g., a vehicle. In an example, the detection device 100 scans the frequency band(s) that will contain the unique signal. In an example, the antenna(s) is uniquely tuned to the frequency band of the stray RF emission. At 706, a sensed signal pattern is matched to a stored signal pattern. In an example, the processing module 101 can apply digital signal processing techniques to pattern match the sensed signal to the stored signals in the database 702. At 708, a log of the pattern match is made. The log can store the pattern, the time and date, and the likely target type (e.g., a vehicle) or the component of the target, e.g., engine type, producing the sensed pattern. At 710, signal enhancement techniques are applied to the matched, sensed signal. Enhancement can include further filtering or applying other signal processing techniques. In an example, the digital signal processor in the processing module 101 processes the sensed, matched signal. At 712, a unit in the vicinity or the nearest unit is alerted that a target of interest has been sensed. In an example, the processor module 101 can notify authorities, such as police, government officials, border patrol, or the military, via electronic communication. These government authorities can then intercept the target or track the target as a item of interest for investigative purposes. In an alternative, the enhanced signal is further processed. At 714, the target heading is determined based on the enhanced signal. At 716, the position of the target is determined and stored. In an example, the processing module 101 determines the position of the target. At 718, the position data is reported. The position data can be reported to further processing structures, which are described herein. In an example, the position data is stored onboard the device and later downloaded to a memory and then uploaded to the further processing structures. After the position and heading are determined (714, 716), this position and heading data can be sent to the nearby units at 712. While the above description uses the term enhanced, it will be recognized that enhanced can mean sampled, filtered, or otherwise processed signal.

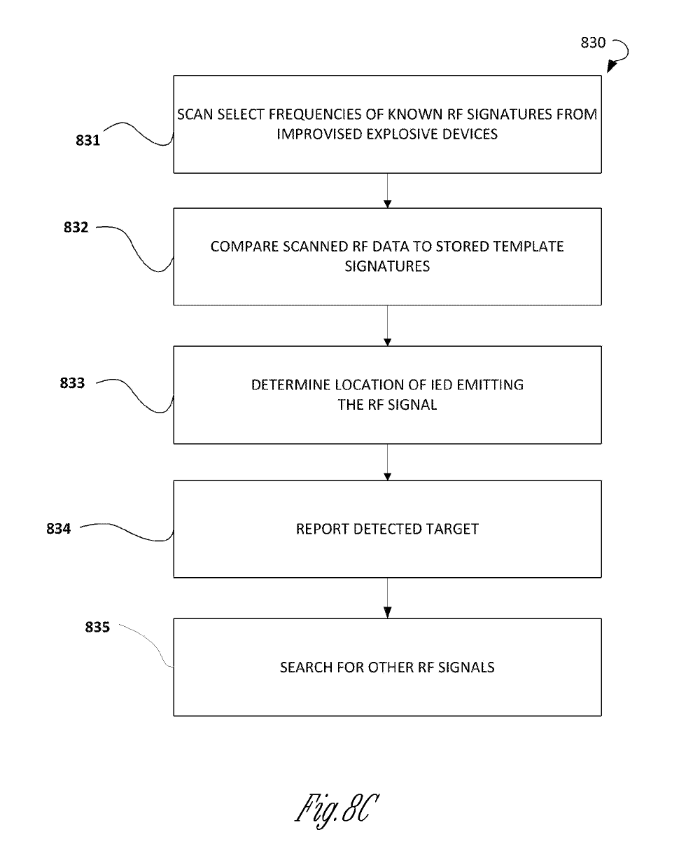

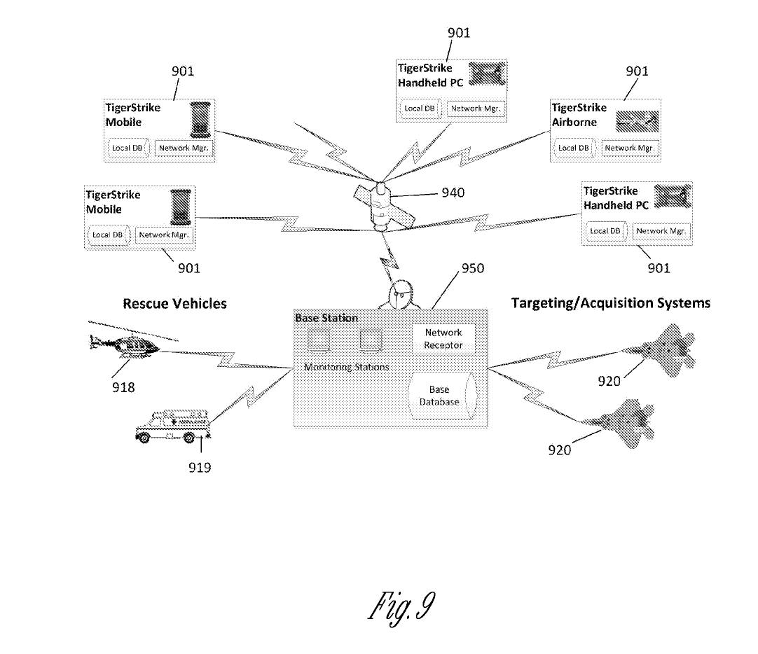

FIG. 8A shows an operating method 800 according to an embodiment of the present invention. At 802, a frequency spectrum, where known stray RF signatures can be found, is passively scanned. The known frequencies can be stray, unintended electro-magnetic radiation from a device or a vehicle. In an example, the stray radiation comes from components of a motor. In an example, the stray radiation comes from components of a transmitting or receiving device, e.g., local oscillators. At 804, the scanned RF data is compared to template of know RF signatures of target vehicles. At 806, the location of the target, e.g., a vehicle, an aircraft, electrical circuitry, radio transmitter emitting the stray RF signature is determined and located. At 808, the detected vehicle is reported.

FIG. 8B shows an operating method 820 according to an embodiment of the present invention. At 821, a frequency spectrum, where RF signatures can be found, is passively scanned. The known frequencies can be those that are associated with communication devices, such as mobile phones, radio transmitters, radio transceivers, amateur radio sets (HAM sets), walkie-talkies, or other mobile communication devices. The known frequencies can be quite broad but usually have distinctive characteristics that can be used to identify the source as a target. Specifically, each radio transmitter has its own unique signal characteristics. The unique characteristics are determined by the tolerances of the individual components and how the device is manufactured. Moreover, lengths and types of connecting cables, e.g., coaxial feeds, will result in distinctive RF signatures for a given target. Once tested and a template is determined, then an individual target radio emitter can be targeted by the present device. At 822, the scanned RF data is compared to signal template data, stored in the device, for potential targets. For example, if searching for a certain type of communication device, its RF signature signal is stored in the device according to an embodiment of the present invention. The device and methods, e.g., at 822, searches the target RF band using its antenna system and compares the sensed signal(s) to the stored template. If a match is found, the location is determined, 823. The determining step 823 can determine the location within about two degrees in elevation and/or within about two degrees in latitude and longitude. At 823, a detected target is reported to another detector or to a base station or to a controller that is part of a vehicle that can investigate the location, e.g., an aircraft, an unmanned aerial vehicle, a ground vehicle, etc. The determined location from step 823 is used to paint the location of the signal. This can be used similar to laser targeting to guide further investigating or guiding bombs or other interdiction efforts. At step 825, the transmissions from the target a monitored. In an example, the transmissions are monitored by the detector. At 826, the further monitored signals are processed. The signals can be radio transmissions that include voice data. The detector can process the voice data in a similar manner as the passively sensed signals. The detector can look for a match in the signal to a known voice pattern stored in the device. The processing 826 can thus identify a specific person as a known target based on the voice pattern match. The processing 826 can use the circuitry 101 (FIG. 1A), the signal processing (analysis) module 126 (FIG. 1B), and/or the correlation module 514 (FIG. 6). The processing can further include sending raw audio data and any match to the raw data determined by the processing 826 to a base station for further investigation, action, or processing.

FIG. 8C shows an operating method 830 according to an embodiment of the present invention. At 831, a frequency spectrum, where RF signatures can be found, is passively scanned. The scanned frequencies are associated with known RF signatures for improvised explosive devices (IEDs). In an example, the handheld detector as described herein is held by a person in a lead vehicle of a convoy. In an example, the detector as described herein is integrated into a lead vehicle. The present method 830, which can use the detectors described herein, may be able to detect at least some known IEDs at a distance of tens of meters and, at times, at one hundred meters or more. At 832, the scanned RF data is compared to signal template data, stored in the device, for potential IED targets. For example, if searching for a certain type of communication device or component of the IED, its RF signature signal is stored in the detector according to an embodiment of the present invention. The device and methods, e.g., at 832, searches the target RF band using its antenna system and compares the sensed signal(s) to the stored template. If a match is found, the location is determined, 833. At 834, the detected target IED is reported. The reporting can notify the group (vehicle convoy, squad, soldiers, etc.) and the bomb squad of the possible IED targeted. It is preferred that the detection and notification ocurr at a sufficient distance to have a margin of safety for the personnel. At 835, other RF signals are searched in an attempt to find the initiation system or device, which would need to send an ignition signal to the detonator to have an IED explode.

While the example of FIG. 8C describes an IED, it will be within the scope of the present invention to use the presently described methods and devices to detect convention explosive devices. In an example, computerized underwater mines can be detected by the methods, devices and systems described herein.

The methods described in FIGS. 8A-8C describe methods of determining the position of a RF signal target. The device, particularly the antenna or antenna assembly, is swept through the target area to determine the position of the target, inclusive of the line of bearing, the distance and the elevation. The taking of multiple readings while sweeping the device results in an exact determination of the position. While the present methods and devices can take multiple readings in time after moving the device to a new position, such a movement is not required as the device and methods operates as a synthetic aperture radar while only rotating the device but not moving the device in it longitudinal or lateral position.

The methods described in FIGS. 8A-8C describe methods of determining the position of a RF signal target using an antenna set that is designed to have a high signal to noise ratio for that particular frequency band. The methods 800, 820, 830 can be adapted for a plurality of different frequency bands that are defined by distinct, individual antenna assemblies. Thus, the methods are adaptable to the antenna assembly as connected to the processing module circuitry 101 or processing module.

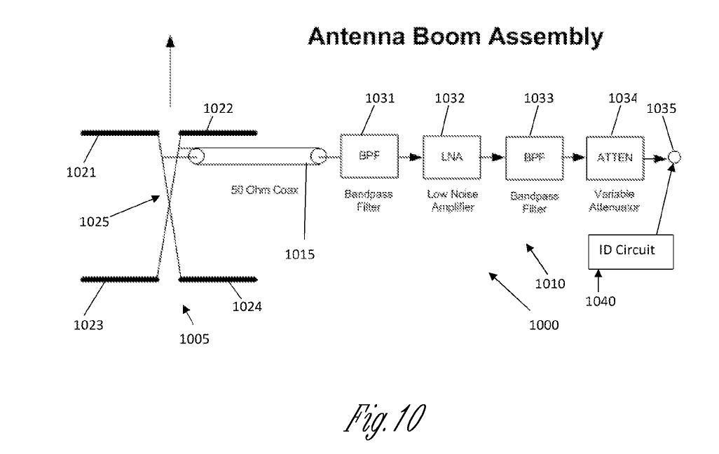

FIG. 9 shows a view of a detection system 900 according to an embodiment of the present invention. System 900 includes a plurality of mobile sensing devices 901, which each include an antenna assembly and detection circuitry. The sensing devices 901 can include the modules and features of detector devices 100 or 200. The sensing devices 901 each include a local database that stores profiles of targets (e.g., vehicles), sensed data, and instructions to execute to compare the sensed data to the profiles of a target that emits a radio frequency signal, e.g., a stray RF signal. As discussed herein motorized vehicles emit such stray signals. Thus, each sensing device 901 can operate on its own to determine the position of an emitter, e.g., a vehicle. The sensing devices 901 can also include a network manager that communicates with a communication system. In the illustrated embodiment, the communication system is a satellite communication system 940. In another embodiment, the sensing devices 901 can communicate over another communication network such as a cellular telephone network. The satellite communication system 940 can relay the data, e.g., the identification or the raw data from the sensing devices, to a monitoring base station 950. The base station 950 includes a network communication manager and a base database to store data from the sensing devices and instructions that can be executed to process the data from the sensing device 901. Various monitoring stations can be associated with the base station and can be monitored by personnel. The monitoring stations can be local to the base station 950 or remote from the base station. The base station 950 is in further communication with rescue vehicles, e.g., airborne rescue vehicle(s) 918 and/or ground rescue vehicle(s) 919. The airborne rescue vehicle(s) 918 can be a helicopter. The ground rescue vehicle(s) 919 can be an ambulance. The base station can further communicate the identified target to targeting/acquisition units 920, which can be fast moving airplanes, unmanned aerial vehicles, boats, or ground vehicles to intercept the target.

In an aspect, the detector units/devices 100, 200 or sensing devices 901 can be integrated into airborne rescue vehicle(s) 918 and targeting/acquisition units 920. In an example, the detector units/devices 100 or sensing devices 901 are connected into airborne vehicles 918, 920 and sense radio frequency signals of interest. If a match is found to a target RF signature signal, then the device 100 or 901 sends the location to the vehicle 918, 920. If a piloted vehicle, the pilot decides to investigate the location either visually or with other sensing equipment. If the vehicle is an unmanned vehicle, its controller can receive the location and fly to investigate the location with other sensing devices, such an imager or a camera. The images from the camera as well as the data from the device 100 or 901 can be sent back to the controller, e.g., using structures and methods similar to those described above with regard to FIG. 4A, 4B, or 9. The presently described detector is suited for use in unmanned aerial vehicles as it is light weight and provides further targeting information that is not currently found in unmanned vehicles.

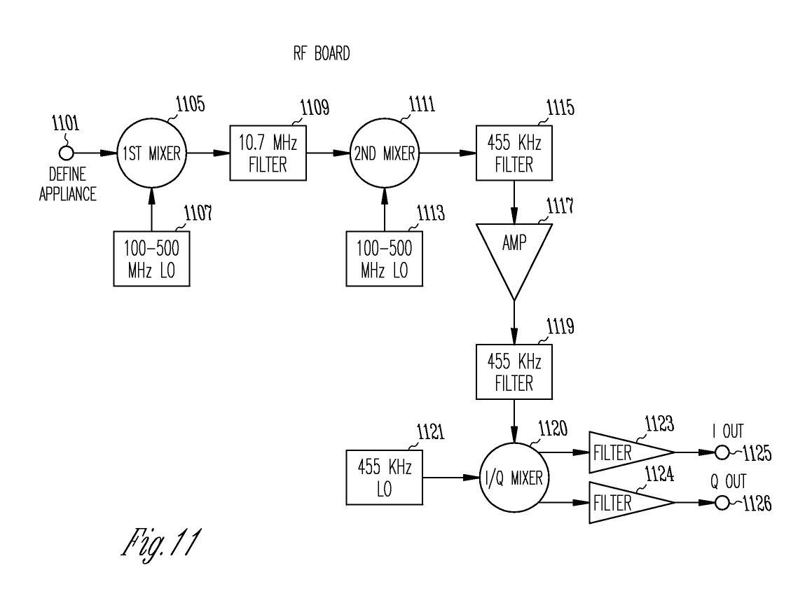

FIG. 10 shows a view of an antenna boom assembly 1000 according to an embodiment of the present invention. The antenna assembly 1000 forms a complete receiver front end to detect a particular band of interest. The band of interest can be for a specific band of stray RF emissions from a target, such as a vehicle. Examples of specific bands include, but are not limited to, antenna/booms for 121.5 Mhz., 146 Mhz., 216 Mhz. and 243 Mhz., +/−about 2 MHz. Antenna 1005 is connected to antenna circuitry 1010 through connection 1015. Each of these elements 1005, 1010, and 1015 can be mounted in a single housing that can be connected to a grip/handle and removably connected to a processing unit. Connection 1015 can be a coaxial cable, e.g., a 50 Ohm resistance coaxial cable. The antenna 1005 includes two pairs of cross coupled elements 1021, 1022 and 1023, 1024. The elements 1021 and 1024 are connected to the inner physical channel of the connection 1015. The elements 1022, 1023 are connected to the outer physical channel of the connection 1015. The elements 1021 and 1023 are the front elements in the housing or relative to the position of a sensing device and the target. The elements 1022, 1024 are the rear elements. An antenna transmission line 1025 connects the elements 1021-1024 to each other and to the connection 1015. Transmission line 1025 can include an impedance transformer between each pair 1021, 1022 and 1023, 1024. In an example, an impedance transformer is positioned on each side of the cross over with the connection to connection 1015 being intermediate the transformer(s). The antenna elements 1021-1024 and the transmission line 1025 are selected based on the specific bands of interest. A bandpass filter 1031 is connected to the antenna elements with the connection 1015. In an example, the bandpass filter 1031 reject signals that are about 20 MHz from the desired signal in the specific band of interest. In an example, the band pass filter 1031 blocks any signal that is 21.4 MHZ from the desired signal. A low noise amplifier 1032 received the output from the bandpass filter 1031. Low noise amplifier 1032 provides a set gain of about 10 dB, about 20 dB, or about 25 dB. A second bandpass filter 1033 receives the output from the low noise amplifier 1032. The second bandpass filter 1033 further limits the signal to the specific band of interest. In an example, the bandpass filter 1033 reject signals that are about 20 MHz from the desired signal in the specific band of interest. In an example, the band pass filter 1033 blocks any signal that is 21.4 MHZ from the desired signal. In a further example, the bandpass filter 1031 reject signals that are about 10 MHz from the desired signal in the specific band of interest. In a still further example, the band pass filter 1031 blocks any signal that is 25 MHZ from the desired signal. A variable attenuator 1034 receives the signal from the second bandpass filter 1033. The variable attenuator 1034 attenuates the signal from the second bandpass filter 1033. In an example, the variable attenuator 1034 attenuates the signal in a range about 4 to about 25 dB. The signal is output to an output port 1035, which is connected to the processing unit. The output port can be a 50 Ohm RF output. The output port 1035 can include other connections, e.g., a voltage supply via a shielded coaxial connection (3.3 Volt), an attenuator voltage control line, and a boom assembly identification port. An identification circuit 1040 can provide a unique identifying signal to the output port 1035 that identifies the type of antenna boom assembly 1000 including the specific band of interest so that the processing unit can appropriately further process the sensed, filtered, amplifies, filters, and attenuated signal to determine the location of the target.

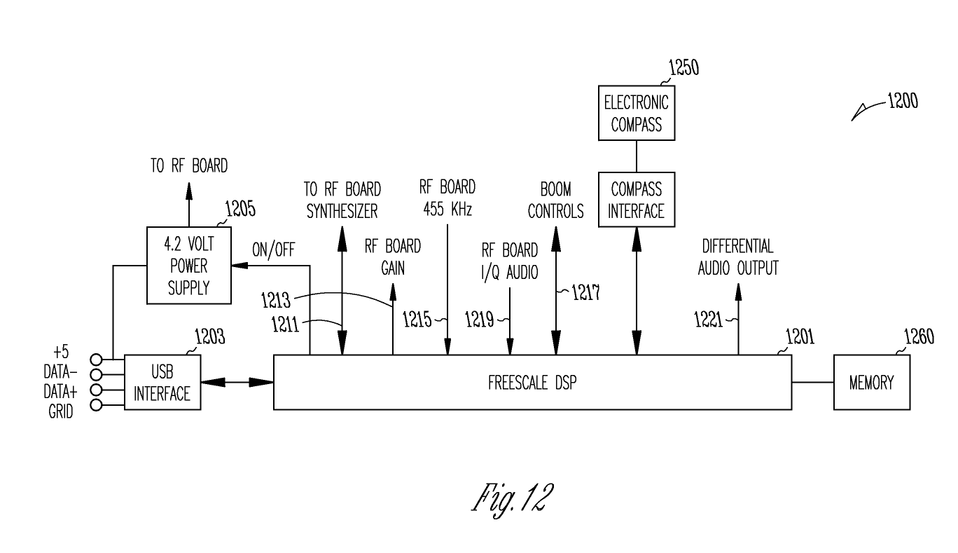

FIG. 11 shows a view of a radio frequency processing circuitry 1100 according to an embodiment of the present invention. An input 1101 is connected to the output of the antenna assembly, e.g., output 1035 of FIG. 10. The input receives the radio frequency signal from the antenna assembly. A first mixer 1105 receives the RF signal and a signal from a local oscillator 1107 to produce a mixed signal. The local oscillator 1107 can input a signal from 100 MHz to 500 MHz into the mixer 1105. Local oscillator 1107 can be a digital synthesizer chip. The mixer 1105 outputs a signal to a filter 1109, which signal represents a frequency shifted version of the signal input to the RF processing circuitry. In an example, the filter 1109 is a bandpass filter or intermediate frequency filter centered on about 10.7 MHz. A second mixer 1111 receives the filtered signal from filter 1109. The second mixer 1111 receives a signal from a local oscillator 1113. In an example, the local oscillator 113 outputs a signal at 10.24 MHz. to the mixer 1111. Local oscillator 1113 can be a crystal oscillator. The mixer 1111 outputs a frequency shifted version of the signal input into the mixer 1111. A filter 115 receives the signal from the mixer 1111. The filter 1115 filters the signal before inputting same into an amplifier 1117. In an example, the filter 1115 is an intermediate frequency filter centered at about 455 KHz. The amplifier 1117 outputs an amplified signal to a further filter 1119. In an example, the filter 1119 is also an intermediate frequency filter centered at 455 KHz. An In-Phase/Quadrature mixer 1120 receives the signal from filter 1119 and a signal from a local oscillator 1121 and outputs an in-phase signal and a quadrature signal to filters 1123, 1124 respectively. In an example, the local oscillator 1121 outputs a 455 KHz signal to the I/Q mixer 1120. Local oscillator 1121 can be a pulse width modulator that is part of digital signal processor, e.g., a Freescale DSP. Filters 1123, 1124 can be Sallen Key active audio filters that provide super-unity-gain amplifier allows with very high Q factor and passband gain without the use of inductors and a pure buffer amplifier with 0 dB gain. The radio frequency circuitry 1100 outputs an in-phase signal at 1125 and a quadrature signal at 1126 after the filters 1123, 1124. It will be understood that the mixer 1105, amplifier 1117, and I/Q mixer 1120 can be incorporated into a single chip.

The receiver circuitry 1100 can further include the mixer 1105, amplifier 1117, and I/Q mixer 1120 can be incorporated into a single chip. Additional connections (e.g., electrical interfaces) may be needed to run the receiver circuitry 1100, e.g., 4.2 Volt power and Ground from the DSP board, the physical releasable connector to RF output from the antenna assembly (e.g., FIG. 9), control lines for the 100-500 Mhz synthesizer, a mux output line from the synthesizer to the DSP board, a gain control for the receiver chip from the DSP board, a 455 Khz IF from the DSP board.

The receiver circuitry 1100 operates to provide a heterodyning or super heterodyning function to the signal received from the antenna. As shown the receiving circuitry 1100 is a triple heterodyne configuration. It will be recognized that the receiving circuitry can be a quadruple or more heterodyne configuration. The receiver circuitry 1100 is thus tuned to the frequency of interest, e.g., by identifying the antenna assembly fixed in electrical communication therewith or by instructions being executed with the processing unit. The digital signal processing circuitry can control the operation and the function of the receiver circuitry.

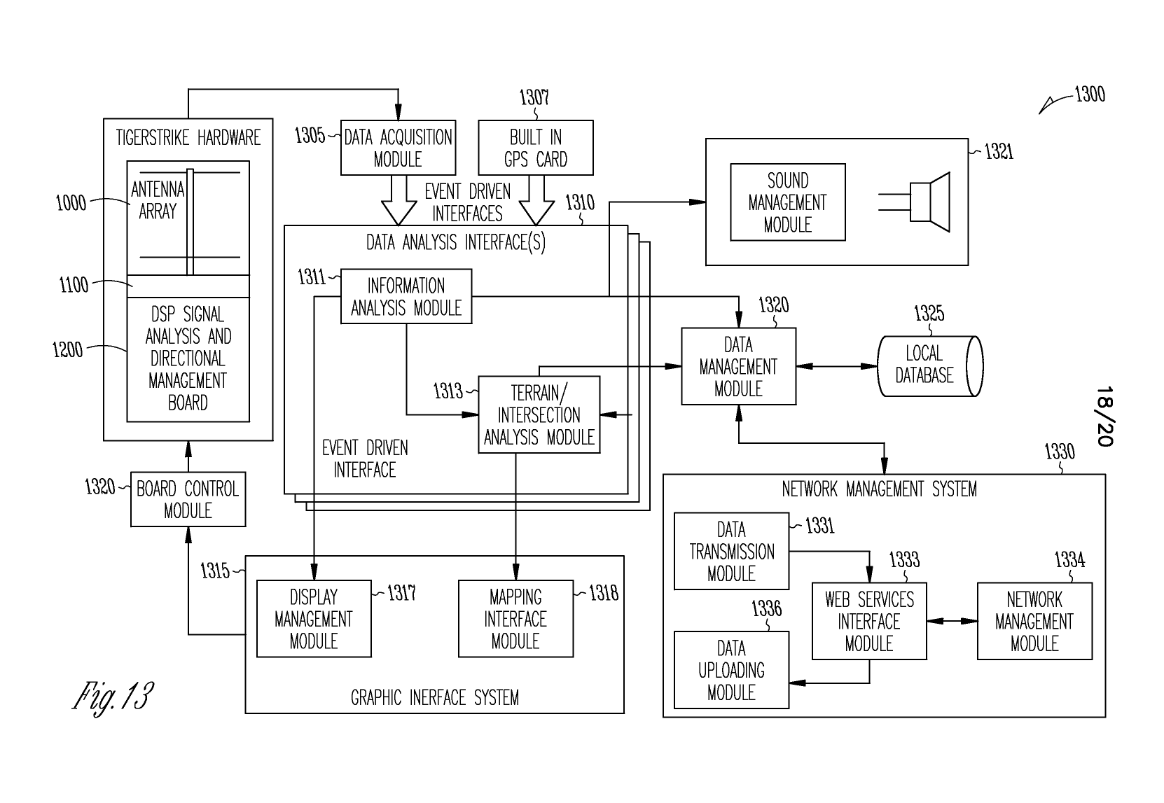

FIG. 12 shows a view of a digital signal processing circuitry 1200 according to an embodiment of the present invention. A digital signal processor 1201 can be a DSP manufactured by Freescale Semiconductor or Austin, Tex., e.g., StarCore DSPs or MSC825x and MSC815x DSP models. The DSP 1201 is in electrical connection with an interface 1203 and a power supply 1205. The interface 1203 allows the DSP 1201 to communicate with systems outside the circuitry 1200 or other circuitry in the detector device. The interface 1203 can be a powered interface, e.g., a universal serial bus with a power port, a ground port, a data minus port, and a data positive port. The power port of the interface 1203 can be connected to the power supply 1205, which outputs the appropriate power, e.g., voltage to the receiver circuitry. The DSP 1201 can output an on/off signal to the power supply so that the power supply only powers the receiver circuitry when the device is on. The power port on the interface 1203 also powers the DSP 1202. The DSP 1201 includes a bidirectional communication link 1211 and other communication links 1213, 1215 with the RF receiver circuitry 1100. Communication link 1211 communications with the chip that operates as at least one of the mixer 1105, amplifier 1117, and I/Q mixer 1120, or all of these elements. Link 1213 is a deliver a signal from the DSP 1201 to the amplifier 1117 with the signal controlling the gain of the amplifier 1117. Link 1215 provides the local oscillation signal to the local oscillation device 1121. Link 1217 is a bidirectional control signal communication with the antenna assembly, e.g., 1000. Link 1219 receives the I/Q signals that are output from the I out port 1125 and the Q out port 1126. At link or port 1221, a differential audio signal is output. This audio signal operates to identify the source of the stray RF, including angular position and distance. In operation the circuitry 1200 powers RF circuitry, the compass 1250, and the antenna assembly 1000. The DSP circuitry 1200 further controls operation of the RF circuitry 1100. The DSP circuitry 1200 receives the I and Q audio signals from the RF circuitry 1100. The DSP circuitry 1200 interfaces directly to the antenna assembly and the position sensor and compass module, providing control and data paths (links). The USB port 1203 comprises a communications channel to the further human or electronics interfaces via a small set of command and data messages. The further interfaces can be the displays, audio or inputs as shown in FIGS. 3A-3C, for example. The DSP circuitry 1200 processes the I input and the Q input from the RF circuitry 1100 to provide a signal strength measurement as well as any required signal demodulation.

FIG. 12 further shows an electronic compass 1250 that connects to the digital signal processor 1201 to provide a compass heading to the DSP 1201 through a compass interface. The electronic compass 1250 can provide a real time heading of the direction the detector device is pointing. The DSP 1201 can associate the heading within one degree to the signal sensed that matches a signal of interest that can be stored in a memory 1260 in electrical connection to the DSP 1201. The DSP 1201 can determine the line of bearing, the distance and the elevation of the target. In an example, the line of bearing, the distance and the elevation are each within 0.1 degree.

The structures shown in FIGS. 10-12 form an RF signal sensing core that provides the signal information needed to by further processing circuitry, software, and instructions that run on electrical circuitry such as a processor.

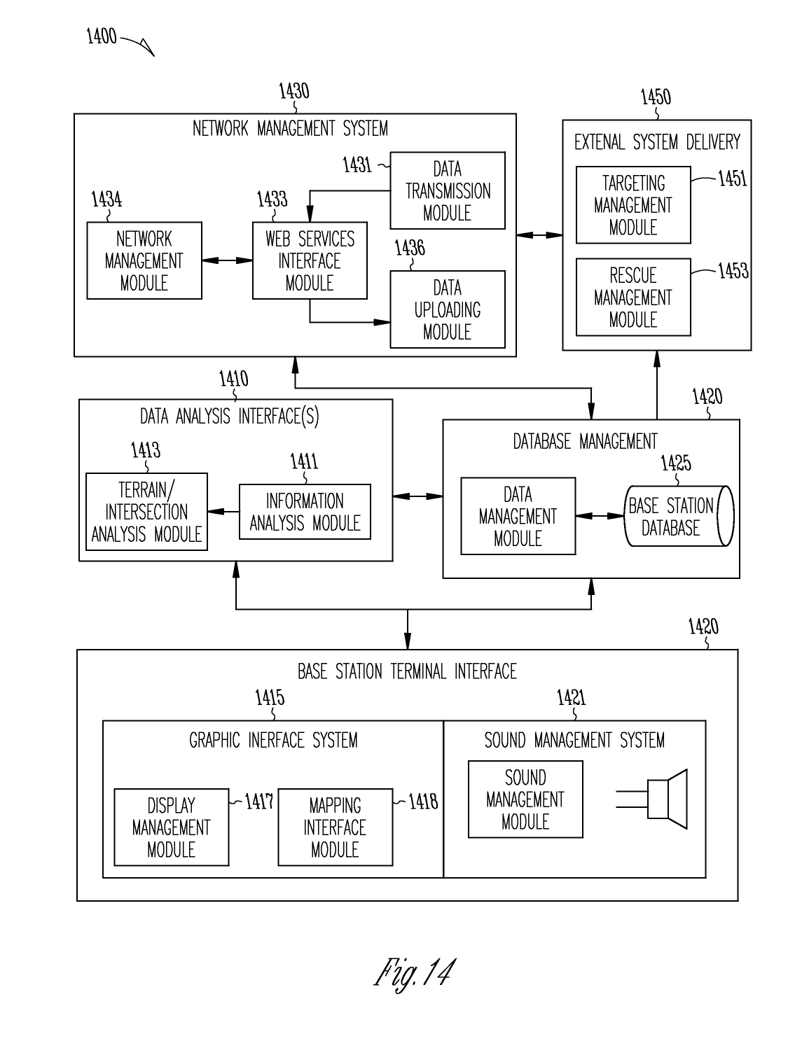

FIG. 13 shows schematic view of a sensing unit 1300 according to an embodiment of the present invention. Sensing unit 1300 interfaces with the antenna array, e.g., antenna boom assembly 1000 or 102A, the receiver circuitry 1100 and the signal processing circuitry 1200. In an example, the sensing unit 1300 can be incorporated in the processing module 101. The sensing unit 1300 includes a data acquisition module 1305 that interfaces with the hardware (e.g., the antenna 1000, RF circuitry 1100 and processing circuitry 1200) that senses the RF signal. The data acquisition module 1305 can connect to the interface 1203. The acquisition module 1305 can include buffer circuitry and memory to store data from the signal processing circuitry, e.g., 1100 and 1200. A positioning system 1307 produces a signal that identifies the position of the unit 1300. In an example, the positioning system includes a satellite positioning system, which can be a circuitry that senses signals from satellites to determine the position of the unit 1300. Examples of a position system include Global Positioning System (GPS), other satellite-based positioning system, a cellular triangulation system, the GPS IIF system, Beidou, COMPASS, Galileo, GLONASS, Indian Regional Navigational Satellite System (IRNSS), or QZSS. These systems can use Real Time Kinematic (RTK) satellite navigation to provide the real-time corrections of the positioning signal down to a meter or centimeter level of accuracy. A data analysis unit 1310 includes an information analysis module 1311 and a terrain/intersection analysis module 1313. A data management module 1320 interfaces with the memory or local database 1325 to control reading, writing or erasing of data from or to both the information analysis module 1311, the terrain/intersection module and a network management system 1330. The information analysis module 1311 processes the sensed the signal from the data acquisition module 1305 or data that has been stored in the memory 1325. In an example, the module 1311 processes the sensed data in realtime. Information analysis module 1311 can use look up tables stored in memory to match data to those of interest. Module 1311 can further current operate in a basic signal mode, an expert signal mode, and a multiple target mode. The basic mode can identify a potential target or merely process the signal and pass it to the data management module 1320 for storage. The expert mode can identify the potential target and provide further information about the target, include movement and tracking of a target. The multiple target mode can track a plurality of targets at once. The navigation position module 1307 feeds the coordinate information unit 1310 to maintain the current location of each mobile device. The data from the position module 1310 is fed directly into the unit 1310 using an event driven model that allows the unit 1310 to perform its work independent of any incoming information. The information analysis module 1311 is to determine the whether a target emitter of stray electromagnetic signals, e.g., a vehicle or receiver or other electronic device, is in the sensing envelope of the device. The information analysis module 1311 can further identify the type of emitter and the position of the emitter. In the expert mode, the unit 1310 provides real time targeting analysis and can feed its results to the mapping module 1313 and display management modules 1315 through an event driven interface. The information analysis module 1311 can derive a location from the I/Q data from the prior processing circuitry. The location can include the bearing, the inclination, and possibly the latitude, longitude and elevation data. A position sensing module 1307 inputs position data into the data analysis unit 1310, which can be combined with other data using the module 1311 to determine the location. A terrain intersection module 1313 access terrain data from the memory 1325 to combine the location with the terrain to further locate the real position of the emitter.

A graphic interface system 1315 provides a human interface and can display information to a user of the device 1300. System 1315 includes a display management module 1317 and a mapping module 1318. The display management module 1317 can display various information that is output from the data analysis unit 1310. The module 1317 can display the information, e.g., bearing, inclination, latitude, longitude, elevation, status of processing, indication that no target is found and other information that will be of interest to a user. In an example, display management module 1317 includes an icon based user interface that requires minimal keyed in input allowing a user to easily manage the application in a field based environment. The mapping module 1318 can display the terrain data in a visual form. The mapping module 1318 can display and keep current a view of the theatre of operations based on the user's current location, and setup parameters provided by the user. Onboard controls on the mapping module allow the user to change the viewing parameters real time in order to support the current search or tactical situation. The terrain data can be stored in the memory 1325. The target sensed by the device can be show on a topographical display. The terrain data can also be used as a navigational aid by the user of the device when displayed by the graphic system 1315. The interface system 1315 can further include user inputs, for example, a touch screen, other manual inputs, buttons or switches. The user inputs can be sent to a board module 1320 to control operation of the digital signal processing circuitry 1200.

The network communication management system 1330 can communicate with other electrical systems, e.g., base station 425, 1400, monitoring server 450, etc. A data transmission module can send or receive data from the device 1300. A data uploading module 1336 operates to control the uploading of raw data from the memory 1325. Web interface module 1333 operates to have the device 1300 communicate over a computer network using various computer network protocols. The network management module 1334 controls operation of the other modules in the system 1330. The system 1330 operates to keep the unit network agnostic, in an example. Accordingly, the unit can work with whatever network the system is currently hooked up to. The system 1330 feeds data analyzed by the data analysis unit 1310 or stored in memory 1325 to the base station and also makes requests to the base station for search and targeting information as analyzed by the base station. The network management system 1330 can also request any outstanding messages from the base station in the form of text messages or other data formats.

The memory 1325 and data management module 1320 operate to store a local database of all the information gathered from the hardware (e.g., antenna assembly 1000, RF circuitry 1100 and processing circuitry 1200). Each of the interfaces of the information analysis module 1311 produces further information that is stored in memory 1325 using different record formats. The data formats are custom designed to support storage using a minimum amount of data storage. The memory 1325 is on board the handheld unit example of the present invention and is portable with the handheld unit. The memory 1325 and data management module 1320 can also provide a full long term memory storage using a thread based lazy storage algorithm that maintains data integrity while minimizing the impact on device performance.

A sound management module 1321 allows the user to receive audible verification of the signal's strength as they use the unit to scan the environment. Module 1321 can be receive control data from the data analysis module 1310. The stronger the signal the louder the sound generated by the sound management module 1321 or the increased frequency of sound or an increased pulse rhythm can be produced by module 1321. In an example, the signal can be fed directly from the processing circuitry 1200 to the sound management module.

The units 100, which can, for example, include antenna assembly 1000, circuitries 1100 and 1200, can be frequency agile and search for patterns at various frequency bands of interest. The antenna assembly 1000 is tuned to specific frequency bands of interest. The units can have a sensitivity of −135 dB.

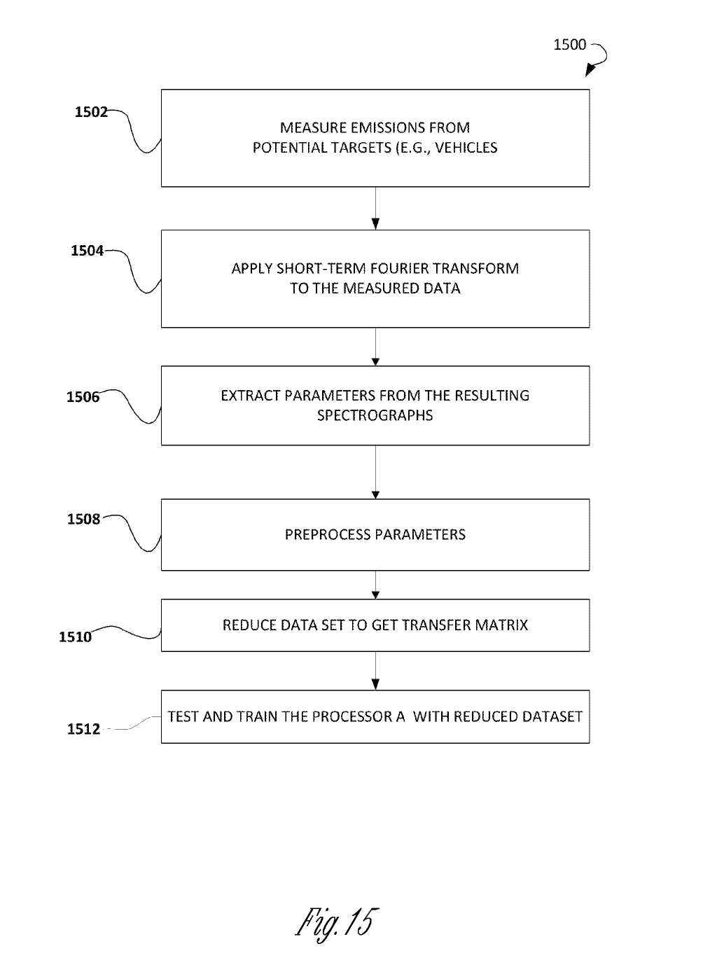

FIG. 14 shows schematic view of a base station 1400 according to an embodiment of the present invention. The base station 1400 receives input from the units (e.g., 100 or 1000, 1100 and 1200) in the field. The base station 1400 records the information and can perform data analysis on the incoming data. The base station 1400 can include software, e.g., instructions that can be stored in a memory and executed on a processor, designed as a series of modules or operatable in modules to provide independent components that interact through a series of event driven or data driven interfaces. The base station 1400 can have similar modules that operate in individual units, e.g., units 100. Similar modules include the same two suffix digits as those used in FIG. 13 with the two prefix digits being 14 for FIG. 14 for ease of understanding. However, the modules at the base station 1400 can operated on data from a plurality of units to identify and locate a target in addition to working on data from a single unit 100.

A network management system 1430 provides a communication interface with units in the field as well as any support systems that are registered to receive information from the base station 1400. The system 1403 is to receive data from units 100 and respond to requests from the field units 100 for information and data updates, including upgrades, latest terrain data, coordinates to search, etc. In an example, system 1430 does not proactively send information out to the field units 100, instead it awaits requests from the field units for updates or data downloads.

The data analysis system 1410 is to integrate the information from multiple units or further process data from a single unit. Data analysis system 1410 includes an information analysis module 1411 and a terrain/intersection analysis module 1413. Information analysis module 1411 further processes raw data from units 100 to identify targets or refine the database of targets. For example, if a signal is identified as a likely target but the signal does not match a target stored in the base station database in memory 1425, the data is flagged to link the data to target information. When targets are identified in the data analysis system 1410, it passes the results into the base station terminal interface, which can include a mapping interface module 1418 and a display module 1417. Personnel can view the results on the graphic interface system 1415 to ensure the information is relevant and correct. Then the personnel can trigger the system 1410 to pass data back into the field units 100 using the network communication management system 1430. A sound management module 1421 can receive instructions from the data analysis system 1410 to provide audio clues to the personnel to alert them to data that has changed or requires user attention.

The database management module 1420 records all data coming into the system and all analytical results and corrections in permanent storage, such as memory 1425.

An external system delivery 1450 responds to requests from a unit 100 and integrated support systems and modules to send data consistent with type of information requested. The system 1450 is capable of providing vector intersection points, coordinates information on other units in the field as well as instructional text messages. System 1450 includes a targeting management module 1451 and a rescue management module 1453. The targeting module 1451 can send data to units 100 in the field to instruct them on where to focus efforts in looking for targets. The targeting module 1451 can also interface with interdiction units, e.g., targeting/acquisition units 920. The rescue management module 1453 can send data to units 100 in the field to instruct them on where to focus efforts in looking for targets that may be in need in rescue. The targeting module 1451 discriminates for adversaries or potential criminals whereas the rescue management module 1453 looks for friendlies or people in need of assistance. The targeting module 1453 can also interface with rescue units, e.g., rescue vehicles 918, 919.

The databases and memory described herein with reference to both the units and the base stations can store RF signature patterns of various targets that emit stray RF signals. The RF signature patterns can be determined and then stored in memory, e.g., in look-up tables. The look up tables can be stored in memory. The look-up tables will include frequency patterns and, optionally, amplitude patterns of the stray RF signals for a given target. Other database storage forms can be used to quickly filter the processed data through the templates of the targets.

FIG. 15 shows a method 1500 to create a method to identify RF signatures that the units 100 can search for in the field. At 1502, the emissions for a target are measured. In an example, the motors for various vehicles are tested and their identifiable stray RF emission is stored as data. In an example, standard circuitry components that are used in communication devices, e.g., signal processors, memories, local oscillators, power generators, etc. At 1504, data processing is performed. In this example, a Fourier transform is performed on the measured data. The Fourier transform can be a short form or fast Fourier transform. At 1506, data that identifies a target is extracted from the spectrographs of the transformed data. At 1508, the parameters are processed. In an example, the mean is set to zero. In an example, the standard deviation is set to one. At 1510, the data set is reduced by applying principal component analysis to produce a transfer matrix. At 1512, the transfer matrix is loaded to an artificial neural network to test and train the network. The neural network can be used in the units 100 to quickly and accurately identify potential stray emission from targets that meet the emission data sets from the measurements.

In summary, during the method as described in conjunction with FIG. 15, stray RF signals are sensed measured and stored from targets, e.g., vehicles favored by drug smugglers, other criminals, or military targets. The distinct, characteristic signature is obtained and can be stored in a look up table. The antenna assembly and circuitry can be tuned to look for the specific signature defined by the stray RF.

Another method for determining the stray RF emissions can be found in U.S. Pat. No. 7,464,005, titled “Electromagnetic emissions stimulation and detection system”, issued to Beetner et al., which is hereby incorporated by reference for any purpose, unless such incorporation conflicts with the present written disclosure and in which case the present written disclosure controls interpretation. However, this patent does not provide distance or location data to targets in the field.

While the above description refers to vehicles such as aircraft, particularly, ultralights and other small planes, it will be understood that the structures and methods described herein can be used to detect other vehicles. For example, boats also emit stray signals that could be passively sensed according to the teachings herein. An example would be sensing marine motors such as Verado brand, 4 or 6 cylinder motors by Mercury Marine of Fond du Lac, Wisconsin. These engines use spark plugs and plug wires, which can be sensed according to the structures and methods described herein. The marine applications may be desirable by the Coast Guard to protect the U.S. borders from unwanted naval entry of people and cargo.

The devices and methods described herein can operate as a software-driven synthetic aperture passive radar device. In operation, a plurality of readings is made over time. These readings operate to simulating a large antenna. In operation, the user of the handheld detector points the detector outwardly and turns in a complete signal in a first direction and then in a complete signal in the other direction. This provides enough different sample points to calculate the position of the target. The user can then point the device at a target. In a further example, a moving target would provide the plurality of different readings over time as the target moves. In the example with the detector mounted to a vehicle or integrated into a vehicle, the movement of the vehicle with detector provides the different points in time to operate as a synthetic aperture radar device.

The software that drives the processing modules or processors can be written in standard programming languages, such as C++, and can be compiled for running on standard operating systems. The processors can be those in YUMA™ tablet computer a NOMAD™ personal data assistant

One approach to locating and identifying vehicles, such as aircraft, involves the use of an active, intentional beacon being broadcast from the vehicle. However, one problem with that approach is vehicles that are being used for nefarious or illegal purposes, such as drug smuggling or illegal border crossings, do not use such active beacons. In some circumstances, vehicles used for these undesirable purposes are specifically chosen for their ability to evade detection and notice. Examples of such vehicles are small aircraft or fast moving boats that can cross the border essentially undetected due to the volume of airspace or the area of the body of water, e.g., the ocean. While some approaches have been attempted, use of military surveillance aircraft, and other aircraft, there remains vulnerabilities that are exploited. One specific example is small, low-flying aircraft. The present inventor identified the problems with conventional detection techniques and arrived at the presently described invention. The beacon system can be used to locate the downed aircraft or boat lost/adrift at sea.

The present systems and methods described herein can further detect, track and local other electrical devices. In an example, a radio receiver can be the target of the present systems and methods. Many electrical signal receivers use crystal oscillators to calibrate the signal they are looking for, and these oscillators give off electrical magnetic interference (“EMI”) noise or stray RF signals. In addition, many receivers go into a different mode of operation, giving off a different EMI profile, when stimulated. Mobile devices and cell phones, when they find a base station, e.g., a tower, go into a more active mode. Many frequency modulation (“FM”) transceivers do the same. This change in signal is another tool that can be used to characterize a receiver and be used in the present devices, systems and methods to identify and locate the emitting device.

The identification of crystal oscillators creates a unique opportunity for the present disclosure to identify improvised explosive devices from a relative safe distance. Many IEDs are made from common, commercial off-the-shelf components. IEDS can be easily hidden on the side of the road, in vehicles, and in buildings. Critical to reducing the threat of IEDs is the development of tools that allow the soldier to easily detect these IEDs in the field. Fortunately, those same off-the-shelf electronics generate stray RF signals, e.g., from their crystal oscillators. The detection of properly profiled unintentional emissions from the IED electronics can be done very quickly from standoff distances (10s to 100s of meters) using the teachings of the present disclosure. The present disclosure can also identify specific electronics known to be associated with IEDs. The electronics used in wireless command-initiated IEDs are particularly good candidates for detection using RF emissions because they must use a receiver which is always active and is attached to a good antenna. The receiver cannot be turned off, the antenna cannot be removed, nor can the device be heavily shielded without disabling the IED. Further, the receiver is specifically selected to react to very small changes in its electromagnetic environment, providing an ideal opportunity to change its unintentional emissions using a very weak electromagnetic stimulation (for example, an FRS receiver will react very reliably to the signal from a 0.5 W transmitter from 2 miles away or more). By looking for this modulated signal from the receiver, the receiver can potentially be detected very accurately even at long range in significant noise, similar to the detection of the very weak signal from a GPS satellite. The present disclosure, e.g., use of a phased array antenna with RF signal profiles is believed to provide an advantage for hunting IEDs.

Various embodiments described herein are designed to provide a solid framework from which radiation based signals can be directionally located, monitored, acquired and targeted for rescue, acquisition, and or identification. The mobile based directional location units described herein come with a self-contained acquisition and analysis system that allows the field user to work autonomously to search for or monitor radio signals and can assist the field user in making decisions about where the source or sources are coming from. Various embodiments described herein can communication with a communication system, e.g., a satellite based network that allows the mobile units to also communicate their information to a base station for further analysis at a different level than the units in the field. The base station can coordinate all incoming data and makes the analysis results available to the units in the field or automatically report to a further analysis system or command center. The coordinated information makes the described technology a formidable solution for locating missing aircraft, Alzheimer's patients (equipped with a radio frequency emitter), and operators using fixed or portable radio equipment.

The present apparatus, systems, structures and methods work on the principals of electronics intelligence and signal intelligence. Electronics intelligence is technical and intelligence information obtained from foreign electromagnetic emissions that are not radiated by communications equipment or by nuclear detonations and radioactive sources. The present disclosure concerns itself with passive detection of stray RF signals from targets and vehicles that are typically not thought of as having stray RF signals. By analyzing the stray electronic emissions from a given target, the present disclosure can often determine type of target and make an educated guess as to its purpose based also on other data, for example, location, speed, height, changes to any of the preceding data, time of day, day of week, etc. The present disclosure uses the principal of electronic intelligence to sense particular band of radio frequencies at which vehicles or other targets, such as receivers, mobile communication devices, emit identifiable signals that can be quantified and identified. The electronics intelligence can identify potential targets to be further investigated, either by people or by signal intelligence systems. The present inventor identified the need for a precise location and detection unit that can identify and locate the position of a potential target. The present invention as described herein provides location and type information that is new and novel.

The present disclosure focuses on detection and identification of stray or unintended RF signals. However, the present device would also work when searching for a beacon or intended signal. In an example, a remote beacon, for example at a ranger station or other location in a remote wilderness, could periodically emit a signal. If a person was lost in this wilderness, then use of the innovations described herein would allow the person to identify the beacon and it exact location relative to the person. The person then could reorient themselves and leave the wilderness. A like scenario can be used to hunt for downed aircraft if it was emitting an RF signal, either a purposed signal or a known unintended signal. In this example, a passenger or pilot of an aircraft may leave their mobile device on as long as the battery holds out as the mobile device would emit some RF signal that could be sensed and located according to the teachings herein.

The units described herein can include a handheld phased array antenna means coupled to a sensitive receiver means for the detection and location of beacons or inadvertently emitted RF profiles. Hardware and algorithms have been developed to detect weak signals and lower the noise threshold to better detect the signals that are being hunted. The units can further include a mobile computer, GPS, and digital compass that can display latitude, longitude, and elevation of a target using heading and inclination from the user's position. The units are frequency agile as a result of its modular receiver that implements instructions to identify and locate stray RF signature profiles of interest. The phased array antenna means can have very narrowband detection for specific targets and have a high gain for that band. The use of the phased array antenna means provides a very selective directional detection, especially, when compared to loop or Doppler antenna.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects (instructions that can be executed by electrical circuitry), firmware, and combinations thereof, as appropriate for particular implementations of various embodiments.

The above description includes references to handheld or mobile detectors or detection units. In various aspects a handheld unit is one that is capable of being held in a hand of a user and being manually used by that user to detect targets as described herein. In an example, the handheld detector has a size and weight to be carried by a person and then held pointing outwardly from the person to take readings. The handheld detector is held outwardly from the body while the person pivots 360 degrees in one direction and then 360 degrees in another direction. In an example, the person then holds the handheld detector toward a target identified by the handheld detector. In an example, the detector is less than six pounds, less than five pounds, and more preferably about four pounds.

The above description includes references to handheld or mobile detectors or detection units. In various aspects, passive refers to sensing and not broadcasting a signal force a response from a potential target. Examples of active sensing include radar. Aspects of the present devices and methods do not emit a signal as part of its sensing function.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A passive target detection system, comprising:
antenna to receive stray radio frequency radiation, the antenna being designed for a frequency range and being removeable when a different frequency range is needed; and
circuitry coupled to the antenna, circuitry to process the received stray radio frequency radiation and to automatically identify a possible target and vehicle.

2. The system of claim 1, wherein the circuitry and antenna are free from interrogation signal being sent to a target.

3. The system of claim 2, wherein the antenna and the circuitry are configured to sense stray radio frequency emission from a vehicle below 10,000 feet from the ground.

4. The system of claim 1, wherein the circuitry includes a battery and a solar power recharger to charge the battery.

5. The system of claim 1, wherein the circuitry is configured to locate a vehicle that is an aircraft with an airspeed of less than 150 knots.

6. The system of claim 1, wherein the circuitry includes a memory storing radio frequency data representing a vehicle and compares sensed radiation with the stored data to determine if a vehicle is present.

7. The system of claim 1, wherein the circuitry is to automatically determine the vehicle type.

8. The system of claim 1, wherein the antenna is a phased array antenna tuned to probable frequencies of stray RF emitting target vehicle.

9. The system of claim 1, wherein the circuitry includes display to display a received signal and directional data that include the line of bearing, the distance and the elevation.

10. The system of claim 1, wherein the circuitry includes a display showing three dimensional data within one degree of the target vehicle.

11. The system of claim 1, wherein the circuitry includes a navigational positioning system.

12. The system of claim 1, wherein the circuitry includes topographical data used to determine a target position.

13. The system of claim 1, wherein the circuitry is to conduct a plurality of reads of received stray radio frequency radiation to identify a target, and wherein the circuitry operates a synthetic aperture radar when only rotating the antenna.

14. The system of claim 1, wherein the circuitry acts as a software driven synthetic aperture passive radar device.

15. A mobile, passive target detection system, comprising:
a handhold;
antenna releasably coupled to the handhold and configured to receive stray radio frequency radiation from a vehicle; and
circuitry module releasably coupled to at least one of the handhold and the antenna, the circuitry module electrically coupled to the antenna, circuitry module to process the received stray radio frequency radiation and to automatically identify a possible target and target position.

16. The detection system of claim 15, wherein the circuitry module comprises a battery and a solar power recharger to charge the battery.

17. The detection system of claim 15, wherein the antenna from a group of antennas is selected to releasably couple to the handhold based on the antenna gain for a narrow frequency range.

18. The detection system of claim 15, wherein the narrow frequency range is selected from a group consisting of about 120 MHz-123 Mhz, about 145 Mhz-148 Mhz, about 155 Mhz-158 Mhz, about 215 Mhz-218 Mhz, about 242 Mhz-245 Mhz, and 400 Mhz-900 Mhz.

19. The system of claim 15, wherein the circuitry module and antenna are free from interrogation signal being sent to a target.

20. The system of claim 15, wherein the antenna and the circuitry are configured to sense stray radio frequency emission from an aircraft below 10,000 feet from the ground.

21. The system of claim 20, wherein the circuitry module is configured to locate an aircraft with an airspeed of less than 150 knots.

22. The system of claim 15, wherein the circuitry module includes a memory storing radio frequency data representing at least one target and compares sensed radiation with the stored data to determine if a target is present.

23. The system of claim 15, wherein the circuitry module is to automatically determine a vehicle type.

24. The system of claim 15, wherein the antenna is a phased array antenna tuned to probable frequencies of stray target.

25. The system of claim 15, wherein the circuitry module includes display to display a received signal and directional data including elevation, distance and line of bearing.

26. The system of claim 15, wherein the circuitry module includes a display showing three dimensional data within one degree or less of the target emitting radio frequency signal.

27. The system of claim 15, wherein the circuitry module includes a navigational positioning system.

28. The system of claim 15, wherein the circuitry module includes topographical data used to determine target position.

29. The system of claim 15, wherein the circuitry module is to conduct a plurality of reads of received stray radio frequency radiation to identify a target.

30. The system of claim 15, wherein the circuitry module acts as a software driven synthetic aperture passive radar device.

31. A passive vehicle detection system, comprising
a mobile detection unit including a plurality of the systems of claims 1-30
a server coupled to the mobile detection unit to further process signals output from the mobile detection unit.

32. The system of claim 31, wherein the server to configured to automatically notify authorities of vehicle detection.

33. The system of claim 31, wherein the server is to notify radar units such that radar unit can focus radar on likely target area.

34. The system of claim 31, wherein the server is send signals to the mobile detection units.
